(19) United States
(12) Patent Application Publication
(10) Pub. No.: US 2002/0027567 A1
(43) Pub. Date: Mar. 7, 2002

(54) Listing network for classified information

(76) Inventor: Bern B. Niamir, Vancouver (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 09/824,093

(22) Filed: Apr. 3, 2001

Related U.S. Application Data
(60) Provisional application No. 60/218,820, filed on Jul. 18, 2000.

(51) Int. Cl. G09G 5/00

(52) U.S. Cl. 345/738; 707/3; 705/26

(57) ABSTRACT

Computer implemented methods and computer systems for locally creating, managing, publishing to peer computers, searching for, and retrieving classified listings are disclosed. Information about the listings is provided to search servers which can be used to locate listings of interest. In some embodiments a system has a central search server which can be queried to locate listings of interest. Other embodiments provide a peer-to-peer computer network which uses a distributed search method. Users can generate listings at their local computers. Listings are stored locally. Listings can include file attachments which can be transferred in a peer-to-peer manner. The system provides a classification data structure, which defines classifications which may be associated with listings. Listings can also be associated with geographical locations. The system may be used to share information about items for sale, upcoming events of interest, services available or needed, or the like.

### CROSS-REFERENCE TO RELATED APPLICATION

This application claims the benefit of the filing date of U.S. application No. 60/218,820 filed on Jul. 18, 2001.

### TECHNICAL FIELD

This invention relates to a computer-based system for publishing and retrieving classified listings. The system has application in disseminating classified advertisements for wares or services and may also be applied to disseminating classified information of other types.

### BACKGROUND

Classified listings are a well-established way for people to share information. The information may be about any of a great many subjects. In a classified listing system, listings are organized for easier retrieval by assigning each listing to one or more categories of an arrangement of categories. The categories may be called “classifications”. The classifications may include sub-classifications. The classifications may, for example, break down goods for sale into different types. Classified advertising in newspapers and magazines is an example of one well-known type of classified listings.

Since the advent of the Internet there have been various attempts to provide classified listings on-line. One well known example of on-line classified listings is the classified listings made available by YAHOO™. Yahoo classified listings can be accessed currently on the Internet at the URL http://classifieds.yahoo.com. A user can user the Yahoo system to post a classified advertisement by selecting a classification for the advertisement from among a number of possible classifications and sub-classifications, and entering details for the advertisement including a title, a description of the goods or services being offered, and contact information. All of this information is stored in a central server from where it is made available to potential purchasers. The Yahoo system is accessed through a web browser, e.g. Microsoft Internet Explorer™. To access the Yahoo classifieds one must have a connection to Yahoo's central server through the Internet. Yahoo does not allow offline creation of listings or the assignment of listings to classifications locally at the user's computer without connection to the central server.

NAPSTER™ is a service for sharing digital music files. Napster is currently available by way of the URL http://www.napster.com. Napster is a music file sharing tool which permits a user to designate music files on his or her own computer which the user wishes to share with other Napster users. In the Napster system a central server maintains an index including author name and song name for music available on users' computers. Users can search the central server for music files that meet their search criteria. Such files are then transferred between user computers in a peer-to-peer manner bypassing the central server. Napster does not allow users to assign classifications to music files, and has no mechanism for making classification assignments available to other users on the network.

Gnutella™ is a distributed file-sharing program which is currently available by way of the URL http://gnutella.wego.com/. There is no central server in the Gnutella system. Instead, searches for content are performed in a distributed peer-to-peer manner. In a Gnutella search, users send search requests to other user computers known to them. Each user computer which receives a search request searches its locally held files to determine whether it can satisfy the request and also forwards the request to other user computers known to it. Because of the manner in which Gnutella searches are conducted, Gnutella searches can take a long time to return results and can generate undesirably large amounts of network traffic.

Reilly et al., U.S. Pat. No. 5,740,549 assigned to Pointcast, Inc. discloses a computer system for disseminating information, including advertising. The information is disseminated from a central server to workstations. Information items and advertising are categorized. Information and advertisements which match a user profile are automatically displayed on the workstation when the workstation is idle. This system does not permit users to create their own advertisements or to search for advertisements in which they are interested.

Woolston, U.S. Pat. No. 6,085,176 assigned to MercExchange, LLC discloses a system for maintaining a market in collectible items. The system includes a central market computer and a number of posting terminals. Users at the posting terminals can enter details regarding an item for sale and the category and sub category to which the item relates. The information is then posted to the market computer. Users interested in purchasing an item can cause the market computer to search its database of items for sale.

Other classified information systems which use a central server to hold information are disclosed in:

Bourquin, U.S. Pat. No. 5,799,284. In this system users can post information regarding products or services for sale to a central server computer. The information includes keywords identifying the products or services. Users can search the server to locate information of interest.

Dworkin, U.S. Pat. No. 4,992,940. This patent discloses an automated system, including a database which contains a large amount of information about different products and/or services arranged in various categories. The information can be accessed by way of a menu-based interface provided on a terminal connected to the system.

Other issued U.S. patents which relate to systems for exchanging information between users include: Bergh et al. U.S. Pat. No. 6,112,186; Lalonde et al., U.S. Pat. No. 5,283,731; Whiteis, U.S. Pat. No. 5,749,081; Walker et al., U.S. Pat. No. 6,108,639; Salmon et al. U.S. Pat. No. 5,592,375; Bixler et al. U.S. Pat. No. 5,745,882; Trader et al., U.S. Pat. No. 5,909,670; and, McGovern et al., U.S. Pat. No. 5,978,768.

Issued U.S. patents which relate to searching distributed databases include: Miller, U.S. Pat. No. 5,506,984.

The inventor has identified needs for methods and systems for: permitting computer users to generate classified listings at their own computers without needing to be connected to a central server, sharing such listings with a community of users over a network, communicating with other users without the intervention of a central server, and providing ways to search for listings and browse listings efficiently.

### SUMMARY OF THE INVENTION

This invention addresses the needs identified above by providing methods and apparatus for creating and classifying listings, and distributing classified listings. The listings are each associated with at least one classification.

One aspect of the invention provides a computer-implemented method for creating, distributing, and searching for classified listings where central search servers include an aggregate of listings from user computer systems and respond to listing queries from user computer systems. The method comprises: providing on a computer network a classification data structure providing a plurality of classifications; providing on the computer network local listing server software which, when run on a user computer system, causes the user computer system to provide a user interface providing facilities for creating, maintaining, and deleting listings from a listings database maintained on the user computer system, each of the listings associated with one or more of the classifications; receiving and storing at one or more search servers connected to the network listing information, the listing information corresponding to listings in the listings databases of a plurality of user computer systems, the one or more search servers comprising a search engine capable of receiving a query from a user computer system, executing the query and returning a result set comprising listing information corresponding to one or more of the listings.

Another aspect of the invention provides a computer-implemented method for creating and distributing classified listings in a distributed search server model where the network address of one or more user computer systems are known to other user computer systems, and the software responds to queries for listings generated at the other user computer systems. The method comprises, at a programmed user computer system: providing a user interface, providing facilities for creating, maintaining, and deleting listings from a listings database; downloading by way of the network a classification data structure defining a plurality of classifications; accepting from a user listing information defining a new listing, the listing information including one or more classifications from the classification data structure to associate with the listing; storing the listing in a listings database; and, forwarding at least some listing information about listings in the listings database to at least one user computer system on the network.

The invention also provides a method for searching for listings in a distributed search server model. The method comprises providing a search query including a criterion identifying a geographical area of interest; identifying a plurality of user computer systems that includes copies of listings from other user computer systems and cover the area of interest; forwarding the search query to the plurality of identified user computer systems; receiving search results from the plurality of identified user computer systems; and, combining the search results.

Another aspect of the invention provides a method for maintaining an index to a plurality of user computer systems in a geographical coverage area. The method comprises: initializing a level 1 distributed search server associated with an initial coverage area; obtaining information identifying a set of user computer systems containing listings in the coverage area; generating and sending to the user computer systems in the set information identifying the search server; and indexing the address of user computer systems.

Yet another aspect of the invention provides a method of searching for listings across geographically distributed user computer systems utilizing a hierarchy of distributed search servers. The method comprises: initializing level 1 distributed search servers on a plurality of user computer systems; on a plurality of user computer systems initializing level 2 distributed search servers with a wider coverage area than level 1 distributed search servers and which include the address of a set of level 1 distributed search servers that fall in their geographical coverage area; initializing successively higher level distributed search servers until a hierarchy of search servers is attained; searching for listings by querying the highest level distributed search servers known; obtaining the address of a set of next lower level distributed search servers; querying this set and successively querying the next lower level until a set of level 1 distributed search servers that satisfy the geographical component of the query criteria are discovered; querying this set for a set of user computer systems that include listings; querying this set of user computer systems for listings; and receiving the listings.

Yet another aspect of the invention provides a program product comprising a computer readable medium carrying signals corresponding to computer instructions which, when executed by a computer, cause the computer to perform a method of the invention.

A still further aspect of the invention provides apparatus for publishing classified listings. The apparatus comprises a processor; a user interface; a locally stored classification data structure defining a plurality of classifications; a database for storing listings; stored geographical location information; and, software which, when executed on the processor, causes the processor to receive listing information defining a listing from the user interface. The processor may be a processor of a personal computer. The listing information includes a selection of one or more of the classifications, and to store the listing information in the database together with the stored geographical location information.

Further features and advantages of the invention are described below.

### BRIEF DESCRIPTION OF THE DRAWINGS

In figures which illustrate non-limiting embodiments of the invention:

FIG. 1 is a block diagram of a listing network according to an embodiment of the invention which uses a central server for servicing search requests;

FIG. 2 is a block diagram representation of a local listing Server (“LLS”);

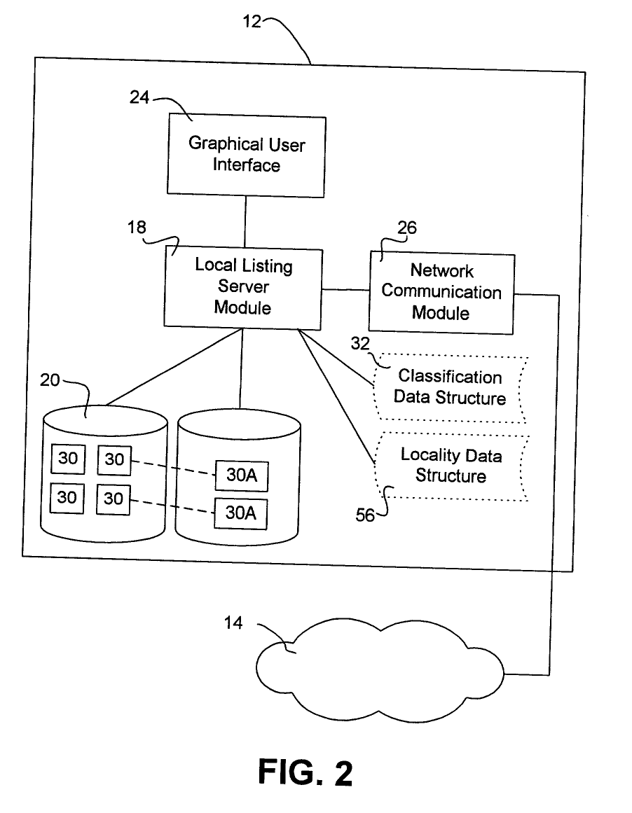

FIG. 3 is a block diagram representation of a central search server (“CSS”) for use in the embodiment of FIG. 1;

FIG. 4 is a representation of a possible graphical user interface (“GUI”) for the local listing server of FIG. 2;

FIG. 5 is a block diagram illustrating an embodiment of the invention wherein there is no central search server and a plurality of local listing servers (“DLLS”) are connected in a peer-to-peer configuration;

FIG. 6 is a block diagram representation of a distributed search server (“DSS”);

FIG. 7 illustrates a coverage set in a system according to the invention having one level of distributed search servers; and,

FIGS. 8A, 8B and 8C illustrate methods according to the invention.

List of Reference Numerals

| | | | |
|---|---|---|---|
| 10 | system | 36 | classification data |
| 12 | user computer system | | structure window |
| 14 | network | 38 | locality data |
| 16 | central search server | | structure window |
| | (“CSS”) | 40 | search/browse results |
| 18 | local listing server | | window |
| | (“LLS”) | 41 | keyword search window |
| 18A | local listing server | 42 | local listings window |
| | (“DLLS”) | 44 | control/status window |
| 19 | distributed search | 48 | computer system |
| | server (“DSS”) | 50 | central search server |
| 19A | level 1 distributed | | software module |
| | search server (“level 1 | 52 | user database |
| | DSS”) | 52A | user index |
| 19B | level 2 distributed | 53 | online user database |
| | search server (“level | 54 | listings database |
| | 2 DSS”) | 54A | locality index |
| 20 | listings database | 54B | grid index |
| 20A | listings database | 54C | classification index |
| 21 | geographical coordinate | 54D | keyword index |
| | server | 54E | tagword index |
| 24 | graphical user | 55 | local coverage |
| | interface | | listings database |
| 24A | graphical user interface | 56 | locality data structure |
| 26 | network communication | 56A | locality data |
| | module | | structure |
| 26A | network communication | 59 | NIC database |
| | module | 60 | NIC database |
| 30 | listing | 61 | distributed search |
| 30A | file attachment to | | server software module |
| | listing | 64 | authentication server |
| 31 | e-commerce server | 100 | system |
| 32 | classification data | 105 | hierarchy server nodes |
| | structure | 200 | method |
| 33 | payment form | 240 | method |
| 34 | acceptance control | 250 | method |
| 35 | confirmation button | | |

### DESCRIPTION

This invention relates to methods and apparatus for generating, maintaining, sharing, and searching for classified listings. In systems according to this invention a listing can be generated at a user's local computer. Listings are made available to a community of interested users. The interested users can retrieve listings of interest and view the listings on their own computers. In this specification the term “listing” is not limited to advertisements regarding the availability of certain goods and services. Listings can have any subject matter at all including notices of special events, announcements, meetings, goods or services for sale or trade, or the like. In general, a listing is a data object containing information that may be of interest to someone other than the originator of the listing.

For example, where the listing is about a house for sale the listing is a data object containing information about the house, such as price and location. As another example, a listing relating to a music file may contain information identifying the name of a song and the name of an artist performing the song. The music file itself may reside on a user's computer. The listing may be presented as text only or may be presented in any of a wide number of formats. In a preferred embodiment of the invention, listings may contain rich text or html information with hyperlink capability.

Each listing is associated with one or more classifications. The classifications preferably include classifications for various types of goods and services for sale, goods and services wanted, announcements, notices, community events, and/or lost & found items. The invention may be used with diverse classification systems.

The classifications may comprise a hierarchy of institutions (such as government, corporations, agencies, organizations, associations, etc.). In this case a listing may be classified institutionally based on an institution to which it relates. Such a classification scheme is useful, for example, for organizing listings relating to various departments in a large organization.

As described below, some embodiments of the invention use one or more central search servers to collect listings (or information identifying listings) and to make the listings available for searching. Other embodiments of the invention use peer-to-peer techniques for making listings available for searching.

A. System Having Central Search Server

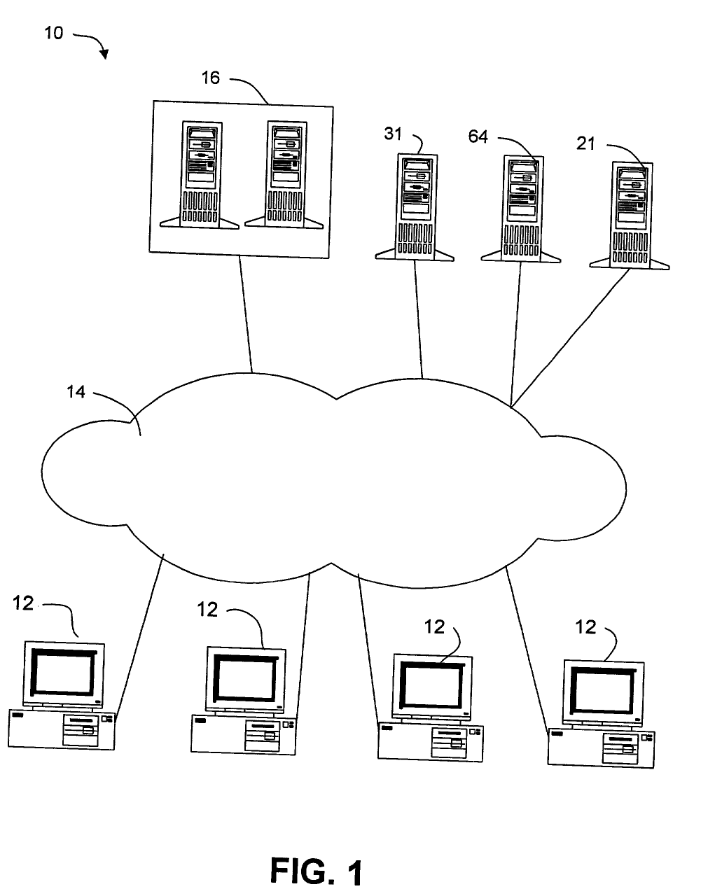

FIG. 1 illustrates one embodiment of a system 10 according to this invention. System 10 includes a number of user computer systems 12 interconnected by a computer network 14. Each user computer system 12 may comprise one or more computers. The set of user computer systems 12 is not necessarily homogenous. There may be major differences in the processing power from one user computer system 12 to the next. The bandwidth of network connections may vary significantly from one user computer system 12 to another.

Network 14 permits bi-directional data communication between user computer systems 12. Network 14 may be a worldwide network, such as the Internet, a local area network, an intranet, an extranet or the like. One or more central search servers (“CSS”) 16 are also connected to network 14.

Each user computer system 12 comprises a local listing server (“LLS”) 18 associated with one or more databases 20. A LLS 18 preferably comprises software running on the user computer system 12 although some functions of LLS 18 could readily be provided in hardware as is known to those skilled in the art.

A suitable user interface, typically a graphical user interface, 24 permits users to interact with LLS 18. A network communications module 26 facilitates communication by way of network 14 between LLS 18 and parts of system 10 on other computers on network 14. The connection between the user computer system 12 and network 14 may be implemented in any suitable way. By way of example only, user computer system 12 may be connected to network 14 by way of: a dial-up connection made with the use of a telephone modem; a cable modem; a DSL modem; a wireless modem; a network interface card; or any other device that provides a data connection between the user computer system 12 and network 14.

Some user computer systems 12 may be on-line most, or all of the time. Other user computer systems 12 may have part-time connections to network 14. These other user computer systems will come on-line at times, and will be off-line at other times.

A user of a computer system 12 equipped with a LLS 18 may use graphical user interface 24 to originate listings 30. The listings may, for example, relate to items for sale by the user, items that the user needs, notices or announcements which the user wishes to broadcast to a community, or digital objects (computer files or other computer objects) that exist on the user computer system 12 or are accessible via network connection. Preferably LLS 18 forces a user to select at least one classification for each new listing 30 as the user originates a new listing 30. The selection may be made in any suitable manner. For example, the user may be prompted to select one of a number of available classifications displayed in interface 24.

A single user computer system 12 may be used by multiple users. Listings originated by different users are preferably stored by LLS 18 in separate databases 20. Graphical interface 24 preferably permits each user to retrieve from their database(s) 20 and edit listings that the user has previously created.

A LLS 18 may be customized for generating listings of a specific type or listings for a particular field of interest. For example, a LLS 18 specially adapted for placing listings relating to real estate apartments for rent may provide a template to guide the user to specify the number of rooms, number of bathrooms, availability of parking, amount of rent, whether or not utilities are included in the rent and so on. LLS 18 may provide a different template for each of several different classifications.

Each LLS 18 is preferably associated with a specific location. Preferably, upon installation of LLS 18 on a user computer 12 a user is prompted to enter address information, such as a zip code, a street address, a street and block number, or the like. The address information is provided to a trusted geographical coordinate server (GCS) 21 which returns geographical coordinates for the LLS 18. The geographical coordinates are stored by LLS 18. These geographical coordinates may be automatically associated with listings 30 which originate at the LLS 18. GCS 21 may optionally be hosted on the same computer that is acting as the CSS 16.

A.1 Classification Scheme

In preferred embodiments of this invention, each listing belongs to one or more classifications in a classification scheme. Preferably, each LLS 18 has access to a classification data structure 32 which identifies classifications to which listings may be assigned. Classification data structure 32 may contain a flat classification scheme which comprises a plurality of classifications, a hierarchy of classifications, sub-classifications and so on, or a group of classifications which are related to one another in a different way. Preferably LLS 18 maintains a local copy of classification data structure 32. A master copy of classification data structure 32 may reside on CSS 16.

A.2 Distribution of Listings

After one or more listings 30 have been created and stored in a database 20, LLS 18 makes the listings 30 available to other user computer systems 12 on system 10. In an embodiment of the invention having a CSS 16, listings 30 are made available by way of CSS 16. Listings 30 may be also, or in the alternative, made available via a peer-to-peer methodology as described below.

In preferred embodiments of the invention, system 10 permits the availability of listings 30 to be restricted so that listings 30 are made available only to users who are members of a particular on-line community. A community is a group of users who share some trait. For example, a community may be a group of users who have indicated that they have mutual interests, who are in geographic proximity to one another, who work for the same employer, belong to an organization, work in a particular industry, or the like.

In the embodiment of FIG. 1, each LLS 18 sends at least some information about listings 30 in each of its databases 20 to one or more CSSs 16. LLSs 18 may periodically send their listings 30 to CSSs 16 or may send information about their listings 60 only in response to a request from a CSS 16. Listings may be transmitted to CSS 16 in response to an “upload” or “commit” action performed by the user. When LLS 18 detects the commit action it sends listing information, preferably copies of listings 30, to the CSS 16. Copies of the listings 30 are stored and indexed at CSS 16. Because CSS 16 stores listings 30 it may be termed a listing server. CSS 16 makes the listings available to other user computer systems 12. In the alternative to requiring a user to perform a commit action, listings may be transmitted to CSS 16 automatically by system 10 either periodically or upon the creation of new listings 30.

Several events take place during upload. In addition to the normal handshake, connection, and user verification actions that take place in order to authorize the user on the CSS 16, the CSS 16 and LLS 18 synchronize their data.

In addition to transmitting data regarding listings 30 to CSS 16, an LLS 18 may also broadcast information regarding its listings 30 directly to other user computer systems 12 as described below in relation to the peer-to-peer embodiment of the invention. In this specification the term “broadcast” means to deliver information in a one-to-many manner. Broadcast is used in a broad and conceptual sense and does not by itself refer to any specific implementation, such as net broadcast, multicast, push or pull technology.

CSS 16 or LLSs 18 may be configured to broadcast listings outside of system 10. For example, where there exists a Usenet group related to the classification and/or locality of listings 30 then CSS 16 may automatically post such listings 30 to the Usenet group. CSS 16 may automatically post listings 30 to an on-line listing service, such as a Usenet group, when the listings match a set of criteria for posting to that on-line listing service.

System 10 operates as follows. Over time, users of user computer systems 12 invoke LLS 18 to generate listings 30. Listings 30 are initially stored in a database 20 on the user computer system 12 from which the listing originated. Each LLS 18 uploads identifying information about its locally stored listings 30 to one or more of CSSs 16. Each listing may include one or more file attachments 30A. File attachments may include, for example, picture files, detailed descriptions, menus, audio or video files or the like. Large file attachments 30A are typically not uploaded to CSS 16. Upon receipt of a new listing 30, CSS 16 stores the listing in database 54 and indexes the listing 30, as appropriate.

A.3 Central Search Server (“CSS”)

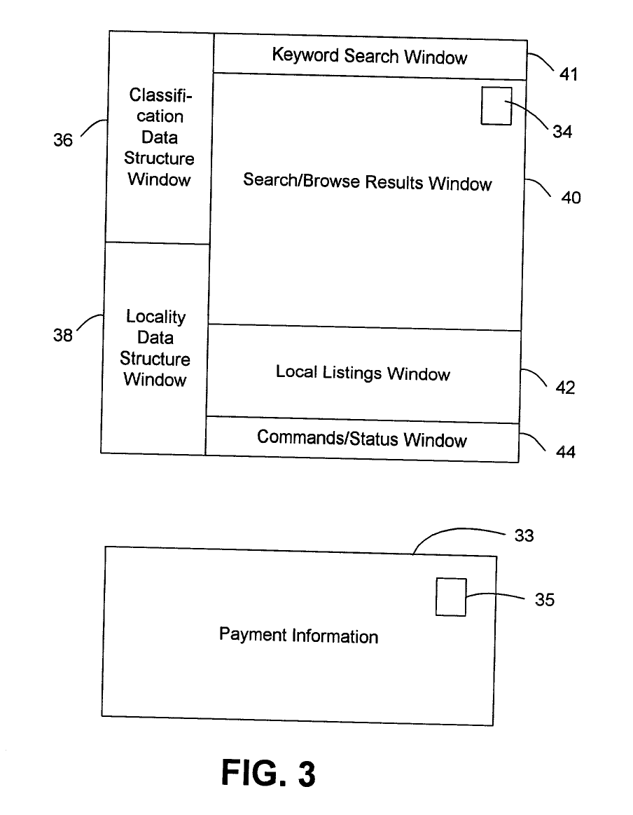

FIG. 3 illustrates a possible embodiment of a CSS 16. CSS 16 comprises a network connected computer 48 running a central search server software module 50. Module 50 has access to a number of databases including a user database 52 and a listings database 54. CSS 16 also maintains a copy of classification data structure 32.

Listings database 54 contains current (and historical) listings 30 which have been uploaded to the CSS 16 from user computer systems 12. Indices 54A, 54B, 54C, 54D, and 54E facilitate the timely retrieval of listings 30 based on certain common attributes of listings. The indices may include, for example, a locality index 54A, a grid index 54B, a classification index 54C, a keyword index 54D, and a tagword index 54E.

CSS 16 also maintains a locality data structure 56. Locality data structure 56 specifies the geographic containment relationships, and other geographic relationships of localities covered by system 10. Locality data structure 56 also contains grid coordinates, in a suitable reference system, which define localities and blocks. For example, data structure 56 may specify the longitude, latitude and approximate radius of a locality.

Locality index 54A identifies listings 30 which are associated with localities (as specified in locality data structure 56). A listing 30 may be associated with a particular locality either because it originated from a user computer system 12 in that locality or because a user has expressly associated a locality with the listing 30. Grid index 54B associates listings 30 with coordinates. classification index 54C associates listings with classifications. Keyword index 54D associates listings 30 with keywords found in the listings (the keywords may be, for example, words found in the header or descriptor of the listings 30). Tagword index 54E associates listings with tagwords. The tagwords are provided to the user that initiates the listings 30 in a pick-list, and the user selects one or more of the tagwords from the list to associate with the listing 30. A separate set of tagwords is preferably defined for each classification. CSS 16 may generate the tagwords in tagword index 54E by analyzing the aggregated classified listings 30 for word frequency. The highest frequency words are included as tagwords in tagword index 54E. Certain common words such as prepositions, ordinary dictionary words and a list of certain words maintained by the systems administrator of the CSS 16 may be eliminated from the tagword list. A LLS 18 may access the tagword index 54E to obtain a list of tagwords available for associating with a listing 30.

A.4 Searching

LLS 18 provides an interface by way of which users can query system 10 to locate listings 30 of interest. The search may involve locating listings 30 which satisfy various conditions. For example, LLS 18 may permit users to request listings 30 which:

are bound to a certain geographic region (or “locality”)—the locality of searches may be as fine as a block of a street in a municipality or a certain street address or may be a larger region. In preferred embodiments of the invention the location of LLSs is specified by coordinates on a grid. The grid may be of any geometry, shape, or resolution. For example, a grid may be congruent to meridians and parallel lines, and be of dimension 1 km by 1 km at the equator. Each locality may correspond to specific grid coordinates or to a specific range of grid coordinates;

are classified in a certain classification;

are classified in a certain locality;

contain certain keywords (A keyword is textual information that is contained in a listing. For example a listing about a house for sale would probably contain the word “house”. A user looking for listings about houses for sale could search for the keyword “house”);

contain certain tagwords (A tagword is textual information which is separate from the text describing the subject matter of the listing. Depending upon the implementation of system 10 a user may be permitted to assign tagwords to a listing 30 to assist others in identifying that listing.);

are related to a certain user;

possess certain attributes; or

match a combination of these conditions.

System 10 returns information identifying a number of listings, if any, which match the user's query. The user's LLS 18 displays this information on the user computer system 12.

In preferred embodiments of the invention, users can cause certain searches to run automatically to monitor new listings 30 and to alert the user when new listings match the user's search criteria. LLS 18 may comprise a user interface which accepts from a user a set of search criteria and stores the search criteria. The LLS 18 can then periodically retrieve the search criteria and execute a search. Preferably a user can specify how frequently the search will be executed. If the search locates any matching listings then the user can be alerted, for example by e-mail, a blinking icon, an audible alert, or the like. The LLS 18 may notify the user only in cases where the search locates a listing which was not previously located or the listing has changed. To do this the software may store a previous set of search results and compare the previous search results to the results of a current search to determine whether the current search has located any new listings or any listings which have changed since the previous search.

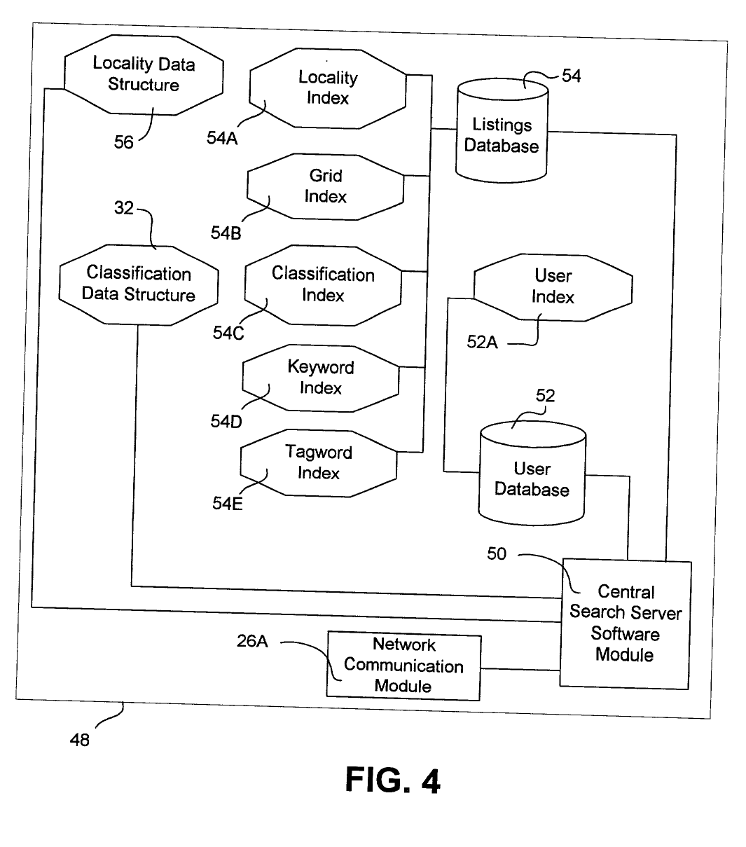

FIG. 4 illustrates a possible user interface 24 for a LLS 18. Preferably user interface 24 is written to conform with the standards and conventions of the operating system of user computer system 12. Unlike browser-based interfaces, such an interface is native to the operating environment and operates in real-time. This provides users with a pleasant and productive interface. Interface 24 may be implemented in any of a wide variety of manners known to those skilled in the art of computer programming.

Interface 24 comprises several windows. The windows may appear on the display of a user computer system 12 independently, or in whole or in part, as sub-windows of a more general window. The important windows include a classification data structure window 36. The classification window displays the classification of a listing 30 in a manner which illustrates the relationship of the classification(s) to which the listing belongs to other classifications in the classification scheme being used.

Locality data structure window 38 displays the locality of interest. Preferably locality data structure window 38 also displays the context of the locality by displaying the relationship of the locality to other localities in locality data structure 56. For example, if the locality associated with a listing is Walnut Grove, Calif. then the locality data structure window may show that Walnut Grove is located in the San Francisco Bay Area, which is in Central California, which is in California, which is in the Southwestern United States, which is in the United States, which is in North America. At any time, one or more localities may be associated with a listing 30 by a user.

Search/browse results window 40 displays the result of search and browse functions initiated by the user. Keyword search window 41 allows searching by keywords.

Local listings window 42 displays the user's listings 30 (from database 20) in one or more sub-windows. For example, items for sale, items wanted, notices, announcements, etc. might each have a separate sub-window.

Commands/status window 44 provides an interface by way of which a user can select various commands to be executed by LLS 18. Commands/status window 44 also displays information about the status of LLS 18. For example, commands/status window 44 may allow the user to select commands which cause the LLS 18 to refresh one or more of the windows of interface 24, to enter a mode in which the user can edit listings 30, to logout or the like. Commands/status window 44 may display various status messages for example an on-line/off-line status indicator.

A.5 Execution of Searches

After CSS 16 has indexed some listings 30 then a user can formulate a query using search/browse results window 40 or keyword search window 41 of interface 24 provided by the user's LLS 18. As a result of the search commands supplied by the user, LLS 18 formulates a search query and forwards the search query to the CSS 16 by way of network 14. CSS 16 searches its indices to locate any listings 30 which it has indexed and which match the query.

In preferred embodiments of the invention, users can initiate a query by selecting a locality. In response, interface 24 displays a list of classifications to select from. Instead of displaying all classifications in classification data structure 32, interface 24 only displays classifications in which there are listings 30 which are also associated with the selected locality. The quantity of listings in that classifications pertaining to the selected locality may also be displayed. This may be accomplished by having CSS 16 create a pruned version of classification data structure 32 which contains only classifications for which there are listings 30 which are also associated with the selected locality. In response to a user selecting a locality CSS 16 returns to the user's LLS 18 all or a portion of the pruned classification data structure 32. The user may continue by selecting a classification from among the classifications of the pruned classification data structure 32.

The reverse can also be accomplished. System 10 may permit a user to select a classification from classification data structure 32 first. LLS 18 transmits information identifying the selected classification to CSS 16. In response, CSS 16 dynamically creates a copy of locality data structure 56 which has been pruned to include only localities for which there are listings 30 in the selected classification. The quantity of listings in each locality, pertaining to the classification may also be displayed.

In the preferred embodiment of the invention each listing is associated with grid coordinates and is not directly associated with a locality. In this embodiment, pruning the locality data structure 56 as described above requires access to an index (which could be grid index 54B) which specifies a range of grid coordinates for each locality of locality data structure 56. This information can be used to determine whether any listings of interest have grid coordinates which correspond with a selected locality. Using the grid index, it is possible to do radial searches whereby listings associated with grid coordinates within a specified proximity from a point may be found.

Preferably when a user selects a classification for a search all sub-classifications of the selected classification are forwarded from the CSS 16 to the user's LLS 18 and are displayed in a window of interface 24. When a user selects a locality during a search it is also preferable that the CSS 16 sends to the users LLS 18 a list of sub-localities. These sub-localities are displayed in a window of interface 24.

After a user has initiated a search by selecting a pair of classification and locality, and issuing a search command by way of interface 24, LLS 18 formulates and sends the query to CSS 16. CSS 16 takes the join of the sets of listings 30 which are in the selected classification and locality. The resulting set of listings 30 is then downloaded to the LLS 18 which originated the query. The LLS displays the result set in search/browse results window 40.

The user may elect to further refine the search by selecting certain keywords and/or tagwords. CSS 16 may download to LLSs 18 lists of available keywords and tagwords (from indices 54D and 54E) so that users can select from the lists.

If the user elects to refine the search then LLS 18 formulates a revised query and delivers the revised query to CSS 16. CSS 16 repeats the search by looking up each of the keywords and tagwords in the appropriate index and performing a multi-way join to produce a new result set. The new result set is then downloaded to the LLS 18 for display to the user in window 40. Consolidation of result sets is not an issue in this architecture as the sets are retrieved from a tightly integrated database on CSS 16 and are consolidated as the join is performed. The result sets may contain entire listings 30 if listings 30 have been uploaded to CSS 16 or may contain links to listings 30 which reside on the user computer systems 12 of one or more LLSs 18.

User interface 24 may include a button or other control which permits a user to rate any listing 30 that did not originate with the user for relevancy. The LLS 18 transmits this information to CSS 16. CSS 16 associates this relevance information with the listing 30 to which it relates. The relevance information may then be made available along with other information about the listing. LLS 18 may be configured to take the relevancy information into account when determining the order in which to display listings received by a search. LLS 18 may be configured to not display listings 30 which have a low relevancy. This may be used to control dissemination of “spam” listings on the system as users will report such listings as having low relevance.

Where a listing 30 has an attachment 30A, the listing contains information identifying the attachment. When a user views the listing then the user may elect to retrieve the attachment. Preferably, each listing 30 includes a network address or “network identification code” (“NIC”) for the LLS 18 that originated the listing. Using this NIC the receiving LLS 18 can issue a retrieve command to retrieve any attachments 30A associated with a listing directly from the LLS 18 at which the listing originated. This can be done using a suitable peer-to-peer file transfer mode. The CSS 16 does not need to participate in this transaction. Information about an attachment may be provided, for example, by including in a listing a hyperlink to the attachment.

Optionally some or all attachments 30A are uploaded and stored on the CSS 16. Where this has been done, if the LLS 18 from which a listing 30 originated is off-line then, after the receiving LLS 18 has detected this off-line condition (for example, by not receiving a response in a timely fashion from the LLS 18 at which the listing originated) the receiving LLS 18 may query the CSS 16 for the attachment 30A and download the attachment from the CSS 16.

Preferably each listing 30 includes messaging information which permits a person viewing the listing at a LLS 18 to establish contact with the person who originated the listing. For example, each listing 30 may include an e-mail address and/or an instant messaging address. User interface 24 preferably permits a user to signal a desire to generate a message to the originator of a listing, for example by pressing a button, clicking on a representation of the listing or the like. When such a signal is received, the LLS 18 opens an interface which permits the user to compose and send a message to the originator of the listing. The LLS preferably logs all messages (both outgoing and incoming) which relate to a listing 30 so that e-mails and instant messages exchanged in respect of a listing can be easily located.

Where the originator of a message can be contacted by way of an instant messaging application then the listing 30 preferably includes the name of the instant messaging application as well as the user's ID. For example, ICQ:xyz may be included in a listing 30 to permit instant messages to be sent to a user with ID xyz in the ICQ application. Preferably LLS 18 is adapted to launch the appropriate instant messaging application, if it is available on the user computer system 12. Preferably each listing provided by CSS 16 is flagged if the user who originated the listing is online and user interface 24 displays a visual indicator (such as a green button) along with a displayed listing to indicate that the Subscriber who originated the listing is online. Each LLS 18 may periodically send messages to CSS 16 to indicate that it is online.

Preferably each LLS 18 caches information such as classification/locality data structures and search result sets which is downloaded from CSS 16. This permits redisplay of previously downloaded information without requiring the LLS 18 to repeat the procedure of requesting and receiving the results of searches from the CSS 16. Caching previously downloaded searches on LLSs 18 both reduces the load on CSSs 16 and avoids concomitant delays. Preferably CSS 16 generates and downloads large result sets incrementally (i.e. pages may be retrieved one at a time) as generally the result set is large and the user is typically interested in the first few pages of the result set and does not care if the complete result set is not yet available.

A user may optionally store retrieved listings in a save file for future reference.

In preferred embodiments of the invention, system 10 permits a user to issue queries for listings 30 based on proximity to the user's location. CSS 16 can use the coordinate information that it has for the user and for other users who have posted listings as a basis for selecting listings 30 which originate within a specified distance from the user and which match other aspects of the user's query. To make such searches manageable, CSS 16 may define a number of grid units having a suitable size. Each grid unit comprises a range of coordinate information. The CSS 16 may record each listing 30 as originating at a specific grid unit. CSS 30 can then locate listings which fall within a specified radius from a user's location by identifying the grid units which fall within this radius and then only considering listings 30 which belong to those grid units.

System 10 preferably includes a web server 21 or other network node device that includes a downloadable version of LLS 18. New users can download and install the LLS software onto their computer system 12. Each LLS 18 contains a network address for one or more CSSs 16 (or the address of a node that contains addresses for one or more CSSs 16). Web server 21 is preferably interfaced to CSS 16 and provides an alternative way for users to manage their listings 30 and also permits users who have access to the world wide web but who have not installed a local search server software 18 to access listings 30 of system 10.

Optionally system 10 comprises one or more authentication servers 64 (FIG. 1) connected to network 14. Authentication servers 64 may comprise software hosted on the same computers that are hosting CSS software 50. Authentication servers 64 receive user ID and password from authorized users of system 10 (or otherwise authenticate the users) and respond with an authentication message. Users who are authenticated can then have their listings 30 synchronized with and saved at a CSS 16 from where they can be retrieved by other users of system 10 for searching. A user may have an account on an authentication server 64 such that by logging on to the authentication server (for example by entering a username and password) the user can authenticate himself/herself.

Preferably listings 30 automatically expire after a certain period. To accomplish this, LLS 18 may automatically set an expiry time for each new listing 30 and then automatically delete the listing or change the listing to an inactive status at the expiry time. Listings 30 which are inactive or have been deleted from a LLS 18 that originated the listings 30 are purged from the CSS 16 by purge processes that are automatically and periodically running on computers running CSS software module 50. Certain listings 30 may be allowed to have long or indefinite expiry dates, effectively turning them into directory listings.

In preferred embodiments of the invention, LLSs 18 permit a user to include sliding scale pricing. This permits a user to specify an initial price, a price reduction value, the time period after which the price will be reduced by the price reduction value, and a number of periods after which the reduction will stop (or the stopping price). The price reduction value may be a fixed amount, a percentage of the initial or current price, or some other function of the initial or current price. CSS 16 (or LLS 18) automatically update the listing 30 to include the current pricing information.

In preferred embodiment of the invention, LLSs 18 permit users to consummate a transaction by responding to a listing 30 of goods and services for sale with terms that are transmitted via peer-to-peer attachments, instant messages or email messages. If such terms are acceptable to the user originating the listing, then the listing user can turn on a “sold” indicator which is then attached to the listing 30, and is communicated to the CSS 16. Alternately, one or more boilerplate contracts may be made available to the LLS 18 at the CSS, to be agreed upon by the transacting parties.

To facilitate such on-line transactions, the user interface preferably provides an acceptance control 34 such as a button, a check box, or other visual confirmation means, whereby both the originator of a listing and another user who views the listing may, at their discretion, both confirm their agreement to entering into a trade, based on the content of the listing. When acceptance control 34 is operated by a user viewing a listing, an acceptance message signifying acceptance of the terms of a listing is automatically sent to the originator of the listing. When the originator of the listing operates his/her acceptance control a confirmation of acceptance message is sent automatically to the user who generated the acceptance message.

Preferably the user interface provides a means by which an originating listing server can cause a form 33 to be delivered electronically to another user who has indicated a willingness to accept an offer contained in a listing. Form 33 is preferably presented by the user interface and permits the person who wishes to accept the offer to enter payment information, such as a credit card number. The form includes a confirmation button 35. By operating confirmation button 35 the user can declare his or her assent to having charges made to a credit card, or other account to complete the trade.

Form 33 may be generated by a trusted e-commerce server 31 on the network. In this case, information on form 33 need not be delivered to other users of system 10. When a user has communicated to e-commerce server 31 that a payment has been authorized and the e-commerce server has performed any necessary validation then the e-commerce server can communicate to the originator of a listing that the funds to complete the transaction have been made available.

Preferably a user who originates a posting can trigger the delivery of a form 33 to another user by actuating acceptance control 34, or a separate control, which transmits information regarding the required payment, the NIC (and/or other identification) of the originating user and the NIC (and/or other identification) of the purchasing user to e-commerce server 31.

By way of example, a first user might post a listing offering a collectable item for sale for a certain price. A second user might conduct a search and locate the listing. The second user wants to purchase the item and activates the acceptance control on the second user's user interface. The second user's local listing server software generates a message to the first user informing the first user that the second user wishes to purchase the item. Optionally the second user may enter a text message to be sent to the first user along with the acceptance. The first user agrees to the purchase by operating the acceptance control provided by the first user's local listing server software (the user interface may provide different controls for sending an indication of acceptance to a first user who posts a listing and to allow the first user to respond to an indication of acceptance by a second user). The first user's local listing server software also sends a message including the address of the second user, the address of the first user and a transaction price to an e-commerce server. E-commerce server 31 generates and sends to the second user a form requesting from the second user payment information. The second user enters, for example, the second user's credit card information and operates confirmation control 35. E-commerce server 31 validates the credit card transaction and sends a message to the local listing server software of the first user that the payment has been processed. The first user can then ship the item to the second user and obtain payment from the operator of the e-commerce server.

In yet another preferred embodiment of the invention, users can conduct auctions, by posting a listing 30 for auction. Other users can bid on the listing 30. Bidding information is communicated by the LLS 18 of the bidding user to the CSS 16. Preferably the LLS 18 of the bidding user also communicates the bid directly to the auction holder's LLS 18 via peer-to-peer communication 26.

A.6 Master of Record

One issue that can arise in a system, such as system 10 wherein there can exist multiple copies of information, such as listings 30, or classification data structure 32 is which copy is the authoritative copy. One can define the “master of record” as being the definitive record that can be relied upon in case of discrepancies between various copies of a listing 30 or other information. The master of record for listings 30 in system 10 may be held locally in databases 20 in LLSs 18 or may be held centrally in one or more CSSs 16.

In some cases it is appropriate to define the master of record as the most recent version of the information in question. In such cases listings 30 may include a time-stamp, version number, or other suitable versioning information. Whenever different versions of the same listing 30 are located they are compared and the most recent version of the listing 30 is used.

Where the master of record is the copy of listing 30 which resides on a LLS 18 then synchronization may involve replacing any previous copy of a listing 30 held at a CSS 16 with a copy of the master of record for the listing 30 from a LLS 18. Other data such as data about the user, data structures specifying available classifications, localities and the like may also be synchronized.

For data for which CSS 16 is the master of record, data from the CSS 16 replaces any local copies of that data held by the LLS 18. For any types of data in which the master of record is the most recent version, then synchronization involves replacing any less recent versions of the data with the most recent version of the data.

B. Systems Having Distributed Search Servers

B.1 General Structure

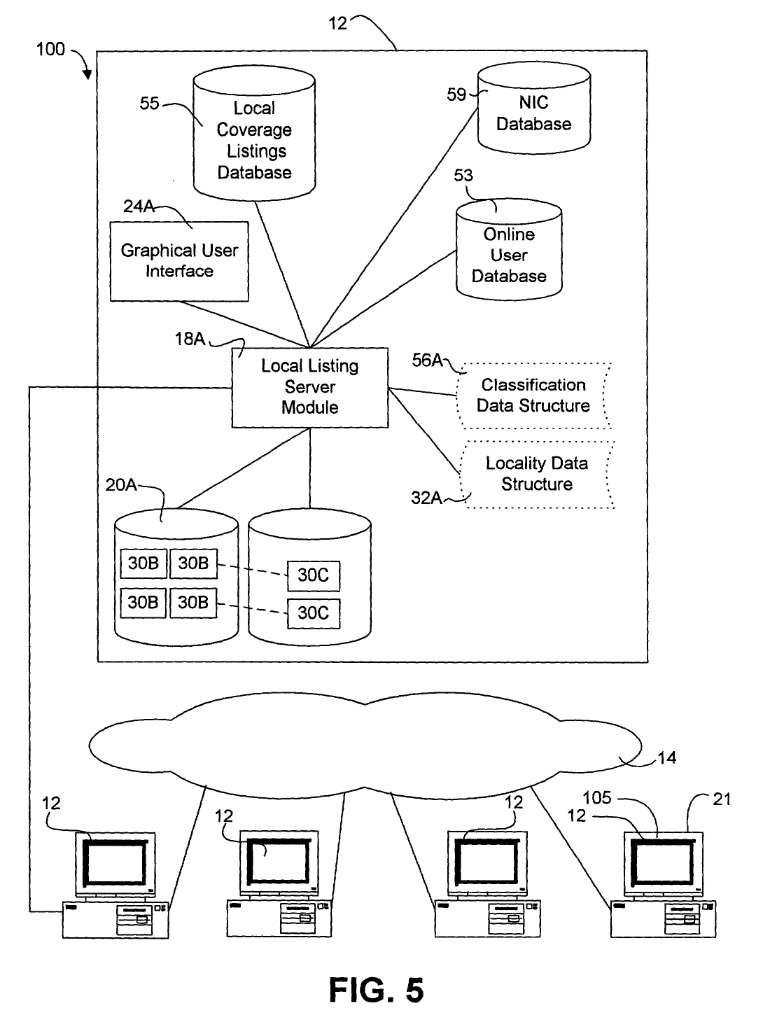

FIG. 5 illustrates system 100 according to the invention. System 100 does not require a CSS 16. System 100 comprises a plurality of user computer systems 12 which communicate with one another by way of a network 14. System 100 is preferred self-organizing, as described below. This permits system 100 to grow to accommodate new users with either no or very little centralized management.

User computer systems 12 comprise distributed local listing servers (“DLLS”) 18A. DLLS 18A typically comprises a software process running on a user computer system 12. DLLS 18A provides functions similar to the functions described above in relation to LLS 18. A DLLS 18A additionally has the capability to receive and store copies of listings 30 which originate at other DLLSs and has functions for receiving and responding to requests for searches for listings.

In system 100 the servicing of search requests is distributed among a plurality of user computer systems 12 which host DLLS 18A. Instead of communicating with a CSS 16, DLLS 18A communicate with one another in a peer-to-peer manner. In preferred embodiments of the invention some user computer systems 12 host distributed search servers (“DSS”) 19. As described below, DSS 19 facilitate searches. DSS 19 can communicate in a peer-to-peer manner with other DSS 19 and with DLLS 18A.

Each DLLS 18A and each DSS 19 can act both as a server (i.e. it can respond to service requests by DSS 19 or other DLLSs 18A) and a client (i.e. it can request information from DSSs 19 or other DLLSs 18A). A DLLS 18A may initiate a query or a transfer, and at the same time may be ready to receive and process queries or requests for transfers of data from others.

One DLLS 18A can cover another DLLS 18A. When a DLLS 18A covers another DLLS 18A, the covered DLLS 18A automatically sends and the covering DLLS 18A automatically receives and stores copies of listings 30 which originate at the covered DLLS. Attachments 30A and other objects related to the listing are generally not duplicated, unless the size of such objects allows for such duplication.

The DLLS coverage set (“DLLSCS”) for a DLLS 18A is defined as the set of other DLLSs whose listings 30 are copied to the DLLS and whose NIC and coordinates are known to the DLLS. Conversely, the DLLS reverse coverage set (“DLLSRCS”) for a DLLS 18A is defined as the set of all other DLLSs that have the DLLS in their coverage sets.

At least some of user computer systems 12 host a DSS 19. DSS 19 enable searches for listings that fall in geographic areas outside of the DLLSCS, of a user's DLLS 18A. Each DSS 19 covers the DLLS 18A which are located in a coverage area. The coverage area is typically defined geographically. A DSS 19 covers a DLLS 18A by maintaining for each covered DLLS 18A a record of:

the DLLS 18A,

the location of the DLLS 18A (for example the geographical grid coordinates at which the DLLS is located),

the coverage of the DLLS 18A (for example, a radius of coverage), and,

the NIC for the DLLS 18A.

For example, a DSS 19 could contain a list of all DLLS located within a certain radius of a point identified by particular grid coordinates.

Preferably there exists a hierarchy of DSSs 19. For example, there may be several levels of DSS 19. Some user computer systems 12 only host a DLLS 18A which manages a database 20A containing listings 30 which originated at the DLLS and its neighboring DLLSs 18A. Others host both a DLLS 18A and one or more levels of DSS 19.

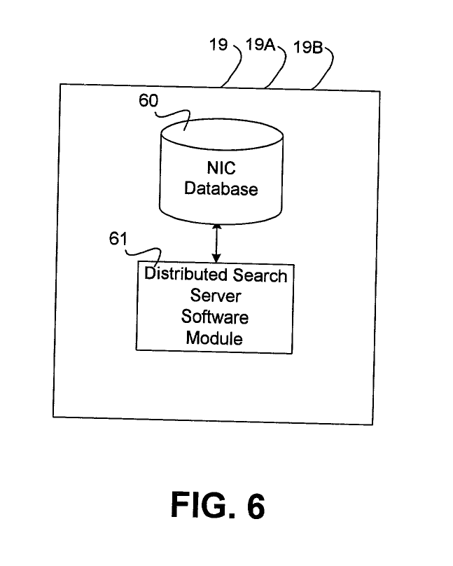

As shown in FIG. 6, a level 1 DSS 19A includes a NIC database 60 which contains the NICs of a set of DLLSs 18A that are in its coverage area. Such set is called the “coverage set” for the level 1 DSS 19A. The DLLS coverage set includes all DLLSs known to the level 1 DSS 19A that have a specified proximity relationship with the level 1 DSS. Conversely the “DSS reverse coverage set” for a DLLS 18A is defined as the set of all level 1 DSSs 19A that cover the DLLS 18A.

The DSS reverse coverage set for a DLLS 18A and the coverage set for a level 1 DSS 19A are defined geographically in the currently preferred embodiment of the invention. The coverage sets could be defined in the alternative as covering certain ranges of keywords, tagwords, classifications, or the like. If so, the proximity relationship will be non-geographic, and suitable for the classification selected, such as lexicographic.

Preferably each DLLS 18A establishes a DLLS coverage set. This may be done by querying one or more level 1 DSS 19A in the DSS reverse coverage set for the DLLS 18A. The DLLS 18A supplies its geographic containment criteria as part of the query. The DLLS 18A receives in return a set of neighboring DLLSs (e.g. a set of DLLSs that meet its current geographic containment criteria). The DSS(s) 19A return the NIC of any DLLSs 18A in their DSS coverage sets that meet the geographic containment criteria. The DLLS 18A then adds the NICs of such DLLSs 18A to its DLLS coverage set.

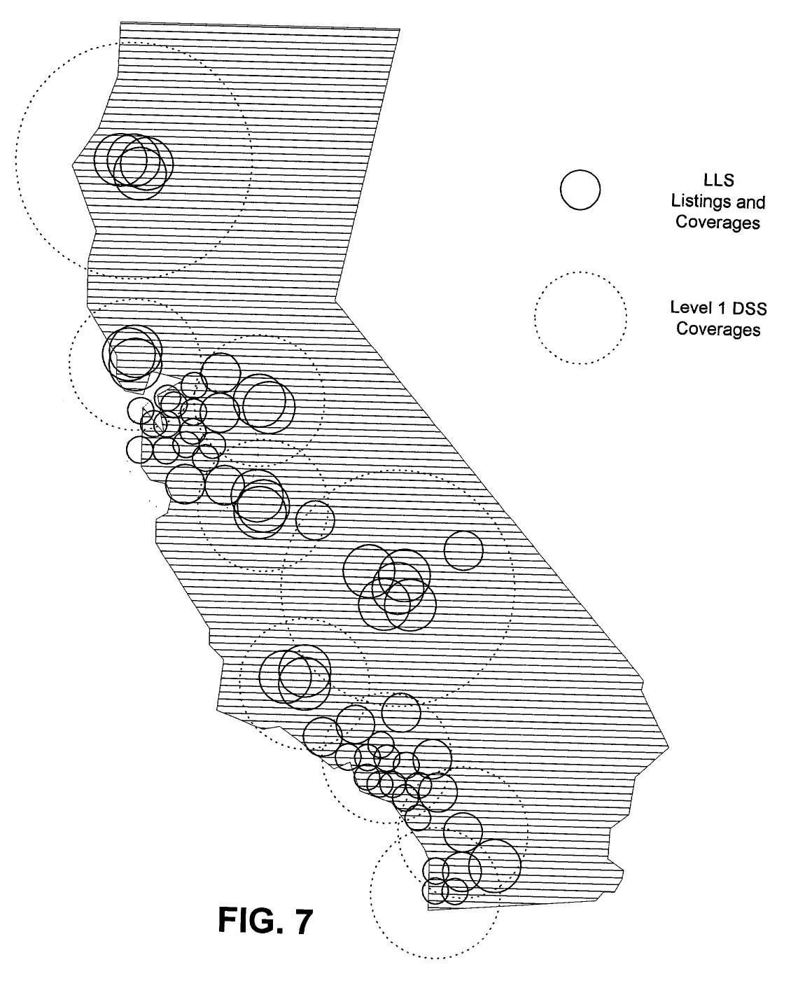

FIG. 7 shows an example of coverages for DLLSs and DSSs in a geographical area, in this case California, USA. Solid circles show areas covered by DLLSs, and dotted circles show areas covered by Level 1 DSSs.

System 100 may include some DSSs 19 which act also as higher level DSSs. For example, a set of “level 2” DSSs 19B acts as a coverage index for the set of Level 1 DSSs 19A. A level 2 DSS 19B has a coverage with a much larger geographic radius than a level 1 DSS 19A such that one or more level 1 DSSs 19A are included in the coverage. Thus a Level 2 DSS 19B acts as a geographic index to the Level 1 DSSs 19A that fall within its coverage. Due to the larger coverage, there need be far fewer Level 2 DSSs 19B than there are Level 1 DSSs 19A. Generally the user computer systems 12 which host Level 2 DSSs 19B should be among those of user computer systems 12 which are more powerful, have higher network connection bandwidth and are connected to network 14 full-time.

Each level 2 DSSs 19B contains information about the coverage of each of the level 1 DSSs 19A. For example, the level 2 DSS 19B may contain the coverage radius for each of the level 1 DSSs 19A in its coverage.

A level 2 DSS 19B can receive queries and direct those queries to selected level 1 DSSs 19A within its coverage. The level 2 DSS 19B identifies a set of level 1 DSSs 19A which at least cover the geographical area specified by the query and directs the query to that set of level 1 DSSs. There may be other higher levels of DSSs 19 which have still larger coverages.

In system 100, each DLLS 18A stores the NIC of DSS's 19 in the highest level of DSSs 19 in its NIC database 59. This can be accomplished by having the highest-level DSS 19 send messages to the next lower level of DSS 19 within its coverage. The next lower level of DSSs 19 send messages to a level below, and so on, until the DLLSs 18A have all been contacted.

B.2 Adding New DLLS

Installation of system 100 may be accomplished by providing DLLS 18A software on public domain download servers, or other file sharing programs.

A user who wishes to have access to system 100 may download and install on their computer system 12 software, which preferably includes DLLS 18A software, and software for various levels of DSS 19. The user installs the software on the computer system 12. Initially only the DLLS 18A needs to run. Upon initialization the DLLS 18A preferably downloads a copy of the classification data structure 32 from a trusted hierarchy server node 105 (FIG. 5) or from another DLLS 18A which has a copy of the data structure 32.

After a DLLS 18A is initialized it needs to become known to the rest of system 100. In a preferred embodiment, each DLLS 18A initially uses search facilities of system 100 (which are described in detail below) to seek out one or more other DLLSs to include initially in its DLLSRCS. The criteria for inclusion in the DLLSRCS include a proximity relationship.

To facilitate the initial connection to system 100 of a DLLS 18A, or DSS 19 the NICs of a highest level DSSs 19 are preferably obtained. This may be done by querying a central site or a domain name server (DNS) that contains such addresses. The address of the central site or DNS may be built into DLLS 18A or obtained somehow by the user and manually entered during the initial configuration of the DLLS 18A. Preferably the DLLS 18A is seeded dynamically during the download with the NIC of the highest-level DSSs 19 that cover it.

One way to provide access to an up-to-date record of highest-level DSSs 19 in system 100 is to provide a network-connected domain name server computer (DNS), or similar central repository, having an address (for example, avalist.com) known to DSSs 19. Each DSS 19 can periodically send an “alive” notice to the DNS. The alive notice includes the level, network address, and preferably location of the DSS 19. The DNS assigns domain names to each of the highest level DSSs 19. The domain names might, for example, be of the form IC-xx.avalist.com, where xx is a number. A new DSS 19 or DLLS 18A can request from the DNS and obtain a list of domain names assigned to the highest level DSSs 19. Such domain names point to the of DSSs 19 which are the highest level DSSs 19 in the network.

In choosing a DLLS for its initial DLLSRCS, the DLLS preferably seek other DLLSs which are hosted on computer systems 12 which have the best connection speed, most available local storage capacity, and highest throughput capacity of the DLLS which satisfy the proximity relationship. Each DLLS 18A adds selected other DLLSs 18A to its DLLSRCS. After this occurs, all listings entered the DLLS 18A are automatically forwarded to other DLLS 18A in the DLLSRCS of the DLLS 18A where they are duplicated. Over time the DLLSRCS will change.

When a first DLLS 18A comes on-line and adds a second, existing, DLLS 18A to its DLLSRCS it notifies the second DLLS that it has done so. This may be done either in the course of sending listing information to the second DLLS 18A or by sending a separate message. The second DLLS 18A then adds the first DLLS 18A to its coverage set. After this has occurred then the first DLLS 18A is known to system 100.

B.3 Creation and Distribution of Listings

In system 100 a user can compose listings 30 on a DLLS 18A as described above with respect to system 10. The master of record for each listing 30 is in DLLS 18A at which the listing 30 was composed. If a listing 30 is changed on its originating DLLS 18A, then the DLLS 18A sends a message to the DLLSs 18A in its DLLSRCS, so that their copies of the listing 30 can be updated.

A listing 30 entered on a DLLS 18A by the user is stored locally, for example on a local disc drive of the user computer system 12. In addition, and over time, the same listing is copied to other DLLSs 18A in the DLLSRCS. These other DLLSs are typically located in geographical proximity to the DLLS 18A.

FIG. 5 depicts an example of system 100 wherein some user computer systems 12 running DLLS 18A not only host their own listings 30 but also include copy of the listings and the NICs of other DLLSs within a coverage area. In the embodiment of FIGS. 5, each DLLS 18A contains listings 30 from other DLLSs within a defined geographical coverage area. The additional listings 30 from other DLLSs 18A within the coverage area are saved by each DLLS 18A in a local coverage listings database 55.

When a user composes a new listing 30 or updates an existing listing 30, the user's DLLS 18A broadcasts a message containing the new or updated listing to all of the DLLSs 18A in the DLLSRCS of the DLLS. These DLLSs 18A add to or modify existing listings in their local coverage listings databases 55.

If certain DLLSs 18A in the DLLSRCS of a DLLS 18A are off-line at the time that the DLLS attempts to upload a new or modified listing 30, then the DLLS preferably tries again later to upload the listing.

To increase the possibility of reception, each DLLS 18A may broadcast on a periodic interval its listings 30 to the DLLSs 18A in its DLLSRCS. This broadcast may involve the DLLS 18A using its locally stored list of DLLSs 18A in its DLLSRCS to establish direct peer-to-peer communication between the DLLS 18A and those DLLSs 18A in its DLLSRCS. In the alternative, each DLLS 18A can query the highest-level DSS 19 of which it is aware for a list of DLLSs 18A that cover it.

Each DLLS 18A maintains indices of the listings 30 within its coverage. Preferably DLLSs 18A maintain a locality index, a classification index, a keyword index, a tagword index, and a user index for all listings 30 in their coverage. These indices function substantially as do the indices of the CSS 16 which is described above. Due to this segmentation by the coverage, a DLLS 18A needs to manage only a small part of the total universe of listings 30. Each DLLS 18A maintains a complete classification data structure 32. Each DLLS 18A preferably periodically accesses a trusted hierarchy server 105 and obtains an up-to-date classification data structure 32. Where there is a plurality of trusted hierarchy servers 105 then the data structures maintained by the hierarchy servers 105 should be synchronized. This may be accomplished by periodically updating all of the data structures at a central location and distributing the updated data structures to all of the hierarchy servers 105 or by providing an updated version of one or more data structures at one of the hierarchy servers 105 and having the hierarchy servers communicate with one another. In an alternative embodiment, the data structures 32 and 56 are maintained on user computer systems 12 running DLLSs 18A and are shared among user computer systems 12 using peer-to-peer data transfer method. Discrepancies between copies of the data structures may be resolved through a versioning convention, or if the user computer systems are not trusted, through a polling and voting mechanism.

Each DLLS 18A also maintains a copy of a relevant portion of the locality data structure 56. Only a small part of this data structure needs to be maintained at any one DLLS. Only locality details that are pertinent to the coverage locality and a summary of locality relationships for outside coverage localities is required. For example, a DLLS located in Washington D.C. might maintain a data structure containing all locality relationships for Washington D.C. and vicinity, but only high-level (e.g. city or region level, and not down to street address) locality relationships for the West Coast.

As shown in FIG. 5, in another embodiment of the invention, the entire locality data structure 56 is maintained at one or more hierarchy servers 105.

B.4 Searching

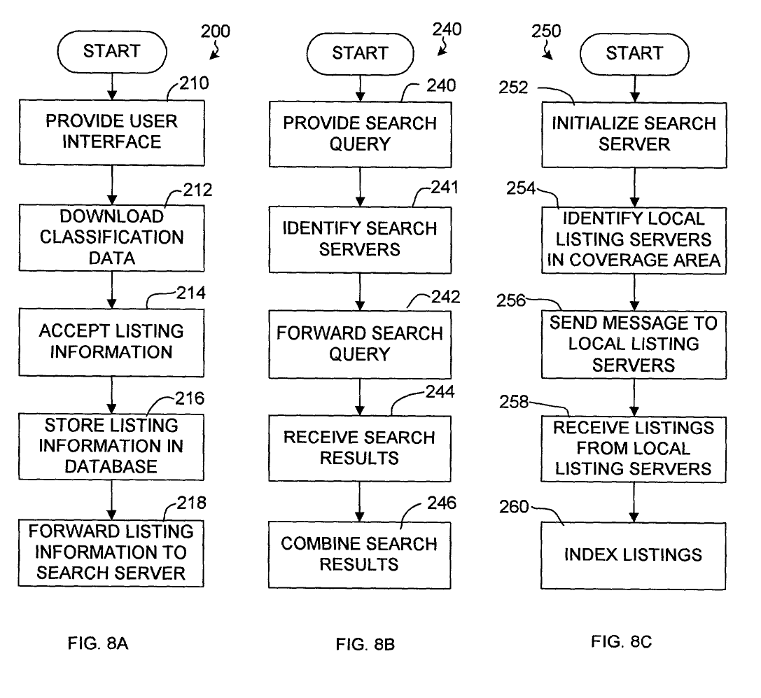

When a user wishes to locate listings of interest to the user, the user invokes interface 24A on the user's DLLS 18A and defines the search (FIG. 8B—240). As part of the search definition the user supplies a geographical coverage for the search. System 100 identifies a “search set” which contains the smallest number of DLLSs 18A which fully satisfy the geographical coverage for the search (step 241). Discovering a search set is preferably performed by having the DLLS 18A generate a message to the highest level DSS 19 that is known to it and which it deems able to satisfy the geographical coverage for the search. The DSS finds the intersection of its coverage set with the search geography criteria to obtain a set of the NICs of next-level-down DSSs which more tightly satisfy the geography criteria. The DSS supplies this set of NICs to the requesting DLLS. The DLLS successively uses the set of NICs thus obtained to query the next lower level DSSs until level 1 DSSs are queried and a set of NICs for DLLSs that minimally satisfy the query geography criteria are obtained.

Each DSS is responsible for determining which part of its coverage set is relevant to the query. This is done by intersecting the geographic area in the DSS coverage set with that of the query. The result will point to a set of DSS of the next lower level which will then receive the query. In this manner, the query is passed down to lower levels, until a minimal set of DLLSs may be found that satisfy the geography criteria. The NIC of such DLLSs are then passed to the originating DLLS conducting the search, who then directly requests each of the DLLS in this set to conduct the relevant search via peer-to-peer communication.

Generally, the DLLS 18A will cache the coverage sets of all DSSs and DLLSs obtained in the course of a search. Such cache will accumulate NICs for DSSs and DLLSs covering localities in which the user of the DLLS 18A tends to search. Preferably the cache is implemented in such a manner that the most frequently used information tends to be retained in the cache.

In some cases a DLLS 18A may already have a cached set of NICs for level 1 DSSs 19A which cover a specific area of interest. The DLLS 18A can provide better search performance if it uses the cached set instead of obtaining a new search set from higher level DSSs. The DLLS 18A may also cache the NICs of higher-level DSSs that have certain coverages. If so, the DLLS 18A can bypass traversing from the highest-level DSS known to it and start querying to obtain a search set from the lowest level DSS that meets its locality criteria and is represented in the cache.

After a search set has been discovered, the DLLS 18A directs the query to each of the DLLSs in the search set (step 242). Each DLLS which receives the query, executes it against its indexes of listings 30 in its coverage, and returns the results to the originating DLLS (step 244). The query is executed by searching database 20A for listings that have been generated locally, and database 55 for listings that have been received from other DLLSs in its DLLSCS. The query will typically include geographical criteria which the listings should satisfy. The DLLS will be able to satisfy parts of the geographic criteria that fall within its coverage. Listings that satisfy the criteria (and all other criteria presented by the query) are forwarded to the requesting DLLS 18A. The search results may be filtered based on classifications, keywords, pricing, or other pertinent criteria. The results will arrive at the originating DLLS in random order and delay.

The DLLS 18A consolidates the search results (step 246) and displays them incrementally so as not to encumber the user with a delay that would be equal to the slowest DLLS to respond. Duplicates are likely since neighboring DLLSs will typically have overlapping sets of listings 30. Consolidation typically entails the removal of duplicate listings 30 and optionally ranking and sorting the listings in the result set.

From the foregoing, it can be appreciated that level 1 and higher DSSs do not actively perform searches for listings 30. These DSSs are only required to perform the discovery of an appropriate search set of DLLSs 18A that cover a specified geographical area. The actual indexing, searching, and filtering of listings can happen on one or many DLLSs. Such activity happens individually and independent of the state of other DLLS that may be in the proximity or may be in the coverage set. The distributed and concurrent nature of the search, and the duplication of the listings across multiple DLLSs, assures that the search can be satisfied by a collection of DLLSs that are acting independently of one other. The originating DLLS is generally responsible to consolidate the results received from this collection.

Most preferably, DLLSs 18A report (for example by sending messages) to level 1 DSSs what load they are experiencing or how much free capacity they have. Preferably, when a search set is being assembled to cover a specified geographical area and there are two or more alternative DLLSs 18A which cover the same portion of the geographical area, then only the DLLS which has the greatest free capacity to handle further searches is made a member of the search set.

As most searches are limited to a specific geographical area, such as a city or a region within a city, it is anticipated that network traffic and server load for most searches on system 100 will be reasonable. However there will occasionally be search requests made at the national or global scale. Preferably DLLSs 18A include logic which discourages users from issuing frequent searches of such nature in order not to overload network 14 and the vast collection of DLLSs that will be enlisted to respond to a search of a global scale. In preferred embodiments of the invention, each DLLS 18A will permit no more than a maximum number of searches to be executed within a given period of time. Most preferably the DLLS 18A issuing the search will send no more than a maximum number of queries to DLLSs 18A in a given period of time. This would permit a user to make multiple searches of limited geographical extent or a smaller number of searches of larger geographical extent.

In this embodiment of the invention, attachments 30A to listings 30 are preferably stored only on the user computer system 12 from which the listings 30 originated and are served in a peer-to-peer manner. In the alternative, attachments which are smaller than a certain threshold, such as thumbnail images, may be cached to other DLLSs 18A. If this has been done then, during any periods when the DLLS 18A from which the listing 30 originated is off-line, the attachment 30A can be retrieved from another DLLS 18A to which the attachment has been cached.

Listings 30 that are deleted are preferably flagged as “deleted” on the originating DLLS 18A instead of being immediately removed from database 20A. This permits other DLLSs to confirm the current status of the listing 30. If another DLLS has received information about a deleted listing 30 and requests further information from the DLLS 18A from which the listing originated then it is preferable that the DLLS 18A reply that the listing has been deleted (instead of indicating that the requested listing cannot be found). Keeping a record of deleted listings can also make historical searches possible. Time stamp or other versioning methods may be used in case of edits and updates to the listings 30.

B.5 Invoking DSS Software

Preferably in system 100 each DLLS 18A contains DSS software 19 so that a DLLS 18A can invoke a level 1, or higher level, DSS 19 on its user computer system 12. Each DLLS 18A may be programmed to invoke a level 1 DSS 19A if certain conditions are met. In the alternative, a user may be presented with the option during initialization of the DLLS 18A software to have the DLLS also invoke a DSS 19 on the user's computer system 12. A user may also be permitted to specify maximum CPU/memory/disk/bandwidth that the Level 1 DSS 19A will be allowed to use. Preferably, the user may opt out of installing DSS 19 on their user computer system 12.

Preferably each DLLS 18A which has been permitted, either through user opt-in or through logic in the code of DLLS 18A, to invoke a level 1 DSS 19A is programmed to also invoke a level 2, or higher level DSS 19 under appropriate conditions. Most preferably the conditions include an element of randomness such that a DLLS 18A may invoke a higher level DSS 19 at random. Most preferably the probability that a DLLS 18A on a particular user computer system 12 will invoke a higher level DSS 19 is increased if the user computer system 12 is more powerful and has a larger bandwidth connection to network 14. This causes higher order DSSs 19 to tend to be hosted by more powerful user computer systems 12.

A user computer system 12 may simultaneously host several levels of DSS 19. Preferably each level of DSS 19 runs as a separate process on a user computer system 12. Because each DLLS 18A which has invoked a 1 level DSS 19A can, at random, invoke higher levels of DSS 19, if there are a large number of level 1 DSSs 19A then a number of level 2 DSSs 19B will be invoked to cover the level 1 DSSs 19A.

During initialization each DSS 19 is preferably informed of one or more higher-level DSSs 19 that can provide it with an initial coverage set of DLLS 18A in its geographical area. For example, a level 1 DSS 19A can request from a known level 2 DSS 19B the NICs and coordinates of nearby DLLSs 18A. The level 1 DSS 19A can use this information to create an initial coverage set of DLLSs 18A that it covers. It can then notify the DLLS 18A that it covers that they should inform it of their listings 30.

When a level 1 DSS 19A is initialized it needs to become aware of the DLLS 18A in its coverage. For example, the coverage of a level 1 DSS 19A may be a geographical region. The region may be a rectangular area defined by a range of grid coordinates, a circle centred on the geographical location of the level 1 DSS 19A or a geographical area defined by some other suitable shape. In the embodiment illustrated in FIG. 7, each DSS 19 has a circular coverage defined by a coverage radius and a location.

Each level 1 DSS 19A periodically broadcasts on network 14 a message identifying its coverage and its NIC. This message may be called a communication message. DLLS 18A who receive such communication messages determine whether or not they fall within the coverage. Where a DLLS 18A does fall within the coverage it saves the NIC of the covering DSS 19A in its NIC database 59. Over time a DLLS 18A identifies and saves the NICs of one or more level 1 DSSs 19A which cover it.

Preferably DLLSs 18A also notify the level 1 DSSs 19A that such DSSs are in their DSS reverse coverage set by sending to those DSSs messages containing the NIC of the DLLSs. Such messages may be called “alive” messages. Each level 1 DSS 19A can, in this manner, create and maintain a list of DLLSs 18A within its coverage.

When a level 2, or other higher level, DSS 19 is initialized it needs to become aware of the next lower level DSSs 19 in its coverage. The new higher-level DSS 19 broadcasts a message indicating its NIC, coverage and level on network 14. DSSs 19 of the next lower level within the coverage record the NIC of the new higher-level DSS 19 and reply with their NICs and coverages. The new higher-level DSS 19 records these NICs and coverages.

In preferred embodiments of the invention the coverage of each DSS 19 is dynamically variable. For example, where coverage is defined by a coverage radius, the coverage radius may be dynamically determined to keep the number of DLLSs 18A covered by a level 1 DSS 19A within a certain range. This range is preferably a function of the capabilities of the user computer system 12 hosting the level 1 DSS 19A so that level 1 DSSs 19A hosted on user computer systems 12 which have better processing power, memory, storage, and bandwidth will have larger coverage radii. When the coverage of a level 1 DSS 19A changes, the level 1 DSS 19A broadcasts its new coverage so that DLLSs 18A can add or delete the level 1 DSS 19A to their DSS reverse coverage sets as appropriate.

Preferably each DSS 19 automatically adjusts its coverage in response to changes in system 100 which result from DLLS 18A and DSSs 19 being added to system 100 or taken off line. For example, if the number of level 2 DSSs 19B becomes excessive (i.e. there is excessive coverage overlap), then some will randomly start shrinking their coverage radii. Where a coverage radius for a DSS 19 drops below a threshold value then the DSS 19 terminates itself. The threshold value is preferably larger for higher-level DSSs 19 than it is for lower-level DSSs 19.

The process of growing and shrinking coverage areas is stochastic across the DSSs 19 and is uncoupled from similar activity taking place in other DSSs 19. In preferred embodiments of system 100 the DSSs 19 at each level are self-organizing so as to maintain overlap and coverage at each of the multiple levels. This may be achieved by programming each DSS 19 to attempt to increase its coverage radius so that it achieves the most coverage. However this will result in excessive overlap of the coverage, which will put unnecessary burden on the DSSs 19.

Therefore, in preferred embodiments of the invention, as a DSS 19 is growing its coverage radius, it inquires as to the coverage of other DSSs 19 in the same general area. This may be done by going through a process akin to searching wherein the DSS 19 begins with a high level DSS 19 known to cover its locality and requests a list of “neighbouring” DSSs 19.

For example, the DSS 19 may request a list of other DSSs 19 which fully or partially cover its own coverage. The search traverses from the high-level DSS 19 until it produces a list of other DSSs 19 of the same level as the DSS 19 which each cover at least part of the coverage of the inquiring DSS 19. The search also preferably provides the locations and coverage radii of these neighbouring DSSs 19. When the DSS detects that there are overlaps between its coverage and the coverage of other DSSs 19 then it checks to determine whether the coverage overlap is excessive. If the overlap is over a certain threshold then the DSS 19 reduces its coverage radius.

Preferably the DSS 19 only reduces its coverage radius if it can do so without causing any DLLSs 18A or lower-level DSSs 19 to be covered by too few DSSs 19. The DSS 19 may, for example, generate a list of the DLLSs 18A which it currently covers but would no longer cover if its coverage radius were to shrink by one unit. The DSS 19 can then ascertain whether or not the DLLSs 18A which would be removed from its coverage are all covered by at least a certain number of other DSSs 19. The other number may be, for example, 3 or 4. If the coverage radius of a DSS 19 becomes smaller than a threshold level then the DSS 19 closes itself down and ceases to operate.

Preferably this process of growing and shrinking of coverage radii for the plurality of DSSs 19 occurs randomly in time. Not all DSSs 19 are attempting to grow or shrink their coverage radii at the same time. The DSSs 19 preferably are programmed to expand and shrink their coverage radii at random times and with necessary amounts of damping so that such oscillatory behaviour is avoided. Since there is little harm in providing excessive coverage, each DSS 19 is biased to grow so that it initially provides excessive coverage. The DSS 19 can then gradually, at random times, determine whether it would be appropriate to reduce its coverage by one unit.

Since a DSS 19 must make enquiries of its peers before reducing its coverage (in order to determine how many of those peers overlap with its coverage area) and since such enquiries can cause significant network traffic, it is generally desirable that there be a significant period between the times that a DSS 19 tests to determine whether its coverage should be reduced. Each DSS 19 preferably maintains a history of changes in its own coverage which it monitors to detect if it is performing coverage changes in an oscillatory or too frequent manner. If the DSS detects that it is changing coverage too frequently then it may maintain its coverage constant for a time period.

The larger the coverage radius, the more storage and processing resources are consumed by a DSS 19. However, system 100 as a whole becomes more robust and responsive if the coverage radii are large. A good rule of thumb may be to assure a minimum of coverage for each DSS 19 while assuring that no more than a certain percentage of processor throughput is consumed by the DSS 19 process.

In some cases the NIC of a user computer system 12 changes each time the user computer system 12 comes on-line. Where a user computer system 12 has a NIC which is not fixed then the DLLS 18A running on that user computer system must inform its DLLSRCS and its DSS reverse coverage set of its new NIC if and when the DLLS comes on-line. If the user computer system 12 also hosts a DSS 19 of any level then the DSS 19 must inform its coverage set and its reverse coverage set of the new NIC. These notifications may be made by sending messages via network 14. For extra robustness, each DLLS 18A may periodically broadcast an “I am alive” message to all DSSs 19 which are in its DSS reverse coverage set so that each of the DSSs will have an up-to-date record of its availability status.

B.6 Modification of Classification Data Structure

System 100 preferably provides some central control over classification data structure 32 and locality data structure 56. If any user could freely update either or both of these data structures then a subversive user could interfere with the proper operation of the whole system 100. Preferably, however, in this peer-to-peer embodiment of the invention the point of control (which may be a hierarchy server 105) provides minimal functions other than protecting the integrity of data structures 32 and 56.

A system according to the invention may permit users to create new sub-classifications. This may be accomplished in various ways. For example, user interface 24A may provide a control which, when invoked, causes DLLS 18A to accept from a user information for creating a new sub-classification. When a user invokes the control, the user's DLLS 18A creates a message defining the new sub-classification and sends the message to a trusted hierarchy server 105. Hierarchy server 105 may automatically add the new sub-classification into its classification data structure 32 (and subsequently synchronize its classification data structure 32 with any other hierarchy servers 105 in system 100). In the alternative, hierarchy server 105 may submit the new sub-classification for review by an editor who can decide whether or not the new sub-classification should be included in classification data structure 32.

If there are no hierarchy servers 105 in system 100 then the DLLS 18A may be configured to poll other DLLSs 18A by automatically generating messages containing the suggested new sub-classification and sending the messages to other DLLSs 18A of which it is aware for a vote. If enough users of the other DLLSs 18A which are polled vote for the new sub-classification then the originating DLLS can incorporate the new sub-classification into its classification data structure 32 and then propagate the updated classification data structure 32 to other DLLSs 18A in system.

After a new sub-classification has been added to the classification data structure 32 then users of DLLS 18A to whom the updated classification data structure has been propagated can then post listings in the new sub-classification.

Preferably a user who creates a new sub-classification can define a set of rules regarding things such as who can post to the sub-classification, what type(s) of attachments are permitted, lengths of posting, etc. In addition, the user may be permitted to create a new locality, and enter that into the locality data structure 32 for the benefit of all DLLSs. This may be accomplished either by user discretion or through editorial control. An example is when the user creates a geographic community such as a university, or a dormitory within a university.

B.7 Embodiments for Facilitating Transactions

Those skilled in the art will appreciate that, in addition to merely making listings 30 available to a wide audience, a system 10 or 100 according to the invention may be configured to facilitate transactions between different users of the system. For example, DLLSs 18A may provide the capability of sending specific types messages between users. These messages may include messages conveying offers to purchase listed items and messages conveying acceptance of offers.

Then, where a first user has an item for sale, the user may create a listing 30 describing the item. A second user who sees the listing 30 may generate an offer to purchase the item. If the first user accepts the offer then the first user causes his DLLS 18A to send an acceptance message back to the DLLS 18A of the second user. At the same time, the acceptance message is broadcast to the DSSs 19 in the DSS reverse coverage set of the first user's DLLS 18A. This changes the status of the listing 30 to “Sold”. When other users subsequently display the listing 30 a status indicator will indicate that the listing is sold. The name of the purchaser may optionally be displayed by the status indicator.

The system may also be used in multi-party dynamic pricing sales. In this model multiple users, in auction format, bid for items that are the subject of a listing 30. The DLLS 18A, which posted the listing about the items on auction, is called the auctioning DLLS. When a bidding DLLS 18A receives a bid for the listing from a user, it sends messages containing the bid to the auctioning DLLS 18A. Preferably, to avoid fraud and resolve race conditions, a bid is only counted as a next higher bid when a certain proportion (for example 80%) of the DSSs 19 in the DSS reverse coverage set of the auctioning DLLS 18A have received and recorded the bid. Although the bidding information is known to the auctioning DLLS, the bidding DLLSs 18A can poll the DSS reverse coverage set of the auctioning DLLS to determine the amount of the current high bid for the item represented in the listing 30.

A system according to the invention may optionally provide users with the ability to create and exchange messages with other users on discussion boards. Preferably, discussion messages are publicly accessible and are made available as threaded message lists, which are attached to listings, and can be viewed by users. The system may optionally provide a facility to rate buyers and sellers similar to the buyer and seller rating performed by the on-line auction company eBay (currently accessible at http://www.ebay.com).

A system according to the invention may have a database containing business advertisements. The advertisements may be displayed as banner advertisements or the like by DLLS 18A while searches are being executed or search results are being viewed by a user. Preferably the advertisements are each associated with one or more classifications, localities, keywords, and tagwords. Preferably advertisements are displayed based on matching the associations with the corresponding classifications, localities, keywords, and tagwords selections in user's search criteria. The advertisements may optionally be displayed and refreshed when the user is not interacting with the LLS 18A but has visible access to the graphical user interface 24A.

The user, whether an individual or a business, may be charged a fee for posting a listing on the system. Additionally charges may be accrued when the user exceeds the posting quota allotted to the user, or if new classifications or localities are created by the user. Certain localities or classifications may be created for a fee only.

Preferred implementations of the invention comprise computers running software instructions which cause the computers to execute a method of the invention. The invention may also be provided in the form of a program product. The program product may comprise any medium which carries a set of computer-readable signals corresponding to instructions which, when run on a computer, cause the computer to execute a method of the invention. The program product may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like or transmission-type media such as digital or analog communication links.

C. Examples

FIG. 8A illustrates one method 200 according to the invention. Method 200 begins by permitting a user to download local listing server software, which includes a user interface, to a network connected user computer system (step 210). When the user invokes the local listing server software it downloads classification data structure 32 from the network (step 212). The local listing server software then accepts information for new listings 30 by way of its user interface (step 214). The listing information is stored in a local listings database (step 216). The listing information is also forwarded to a listing server which covers the local listing server (step 218). The listing server may be a CSS 16 or a DLLS 18A.

FIG. 8C illustrates another method 250 according to the invention. Method 250 begins by initializing a search server (step 252). The method continues by identifying local listing servers within the initial coverage of the listing server (step 254). The method then sends a communication message to each of the local listing servers indicating that the local listing servers which receive the communication message are covered by the listing server (step 256). The local listing servers respond by sending copies of the listings which originated at those local listing servers to the listing server (step 258). The listing server then indexes the listings (step 260). The listing server can subsequently service requests for searches of listings which fall within its coverage.

As will be apparent to those skilled in the art in the light of the foregoing disclosure, many alterations and modifications are possible in the practice of this invention without departing from the spirit or scope thereof. For example, it will be understood from the foregoing that in systems according to various embodiments of the invention:

listings may be either consolidated centrally at a central search server, segmented across a plurality of central search servers or distributed across a plurality of local listing servers.

Searching and browsing may be either performed centrally using one central search server to receive and process queries, performed across a plurality of central search servers with segmented databases, performed concurrently across a plurality of local listing servers or performed in a combination of any of these ways in a hybrid manner.

The search results may be consolidated in whole or in part at the central search server, or at the local listing server from which a query was initiated. Consolidation or joins may also be performed by local listing servers other than the querying local listing server. This would require peer-to-peer communication between any two local listing servers, and can potentially increase the throughput when performing queries with wide coverages.

Local listing server and distributed search server may each consist of a plurality of interacting software components. Software components may be shared between local listing server and distributed search server.

User computer systems 12 could include wireless access to the network via a wireless network communication module. Examples of such user computer systems 12 include personal digital assistants (“PDAs”) , web-enabled cell phones, or the like. Local listing servers on such devices would receive or upload listings via the airwaves.

Accordingly, the scope of the invention is to be construed in accordance with the substance defined by the following claims.

What is claimed is:

1. A computer-implemented method for creating and distributing classified listings, the method comprising, at a programmed user computer system:
a) providing a user interface providing facilities for creating, maintaining, and deleting listings from a local listings database;
b) downloading by way of the network a classification data structure defining a plurality of classifications;
c) accepting from a user listing information defining a new listing, the listing information including one or more classifications from the classification data structure to associate with the listing;
d) storing the listing in the local listings database; and,
e) forwarding at least some listing information about listings in the local listings database to at least one search server on the network.

2. The method of claim 1 wherein the listing information comprises locality information.

3. The method of claim 2 wherein the user computer system is associated with a locality and the locality information identifies the locality associated with the computer system.

4. The method of claim 3 comprising obtaining the locality information by forwarding all or part of a street address at which the user computer system is located to a geographical coordinate server on the network, receiving the locality information from the geographical coordinate server, saving the locality information at the user computer system, and automatically associating the locality information with listings originating at the user computer system.

5. The method of claim 1 wherein one or more of the listings in the database comprise attachment files stored on the user computer system and the listing information comprises information identifying the attachment files.

6. The method of claim 5 comprising receiving at the programmed user computer system a request for one of the attachment files by way of the network and responding to the request by sending the attachment file on the network.

7. The method of claim 3 comprising conducting a search by:
a) receiving a query by way of the user interface, the query comprising a locality criterion;
b) forwarding the query to a search server on the network; and,
c) receiving from the search server listing information in response to the query.

8. The method of claim 3 comprising conducting a search by:
a) composing a query, the query comprising a locality condition;
b) requesting from one or more distributed search servers on the network, and obtaining, a set of local listing servers on the network which match the locality criterion;
c) forwarding the query to the local listing servers in the set;
d) receiving search results from at least some of the distributed local listing servers in the set.

9. The method of claim 8 wherein the one or more distributed search servers comprise a search set comprising a set of lowest-level distributed search servers which match the locality criterion and the method comprises obtaining the search set by:
a) requesting from a higher-level distributed search server on the network a list of lower-level distributed search servers on the network which match the locality criterion;
b) receiving a list of one or more lower-level distributed search servers which match the locality criterion from the distributed search server;
c) if the lower-level distributed search servers on the list are not lowest-level distributed search servers repeating steps (a) and (b) for each of the lower-level distributed search servers until the search set comprising a list of lowest-level distributed search servers which match the locality criterion is obtained.

10. The method of claim 9 comprising receiving information about the load each of the lower-level distributed search servers is experiencing and eliminating from the list those one or more of the distributed search servers which are experiencing the highest loads.

11. The method of claim 10 comprising receiving from the distributed search servers information about loads being experienced by each of the local listing servers and eliminating from the set of local listing servers those one or more of the local listing servers which are experiencing the highest loads.

12. The method of claim 8 wherein the one or more distributed search servers comprise a search set, the search set comprising a set of lowest-level distributed search servers which match the locality criterion, the method comprises caching search sets corresponding to one or more locality criteria and, if there exists a cached search set for the locality criterion of the query, forwarding the query to the lowest-level distributed search servers in the cached search set.

13. The method of claim 8 comprising receiving and displaying by way of the user interface search results comprising listing information for one or more listings which match the query.

14. The method of claim 13 comprising, at the user computer system, consolidating the search results by at least removing duplicates from the search results before displaying the search results.

15. The method of claim 13 wherein the listing information comprises information identifying a location of an attachment to a listing and the method comprises requesting and receiving the attachment by way of the network.

16. The method of claim 15 comprising requesting a copy of the attachment from a search server on the network if the requested attachment is not received before a specified time.

17. The method of claim 13 comprising periodically receiving at the user computer system by way of the network, and storing, a classification data structure and a locality data structure.

18. The method of claim 1 comprising broadcasting listing information about listings in the local listings database to a plurality of other user computer systems on the network.

19. The method of claim 18 comprising maintaining at the user computer system a list of one or more local listing servers covering the user computer system.

20. The method of claim 19 comprising accepting from a user instructions to modify a listing in the local listings database, and sending updated listing information to the at least one local listing servers on the list of local listing servers covering the user computer system.

21. The method of claim 20 comprising determining that one or more of the at least one local listing servers is offline and automatically attempting to resend the updated listing information to the one offline local listing server after a delay.

22. The method of claim 1 comprising broadcasting a network address for the user computer system to at least one search server to cause the search server to cover the user computer system.

23. The method of claim 1 wherein the listing information comprises an initial price and the method includes receiving from a user information including a price reduction and a time period upon which the price reduction should be effective and automatically modifying the listing after the time period has elapsed to reflect the price reduction.

24. The method of claim 1 wherein the user computer system comprises a distributed local listings server covering one or more neighboring user computer systems and the method comprises receiving by way of the network and storing locally at the user computer system listing information from the one or more neighboring user computer systems.

25. The method of claim 24 wherein the distributed local listings server covers other distributed local listing servers in a geographical coverage area and the method comprises determining if the user computer system has sufficient resources to permit expanding the geographical coverage area to cover additional distributed local listing servers, and, if so, expanding the geographical coverage area.

26. The method of claim 25 comprising obtaining information about the geographical coverage areas of neighbouring distributed local listing servers, determining whether the geographical coverage area of the distributed search server overlaps excessively with geographical coverage areas of the neighbouring distributed local listing servers and, if so, reducing the geographical coverage area of the distributed local listing server.

28. The method of claim 1 comprising running on the user computer system a lowest level distributed search server, the lowest level distributed search server causing the user computer system to maintain a list of network addresses and coverage of one or more local listing servers in a coverage area of the lowest level distributed search server.

29. The method of claim 28 comprising comparing a coverage radius of the lowest level distributed search server to a threshold value and discontinuing operation of the lowest level distributed search server if the coverage radius is less than the threshold.

30. The method of claim 28 comprising obtaining information about the geographical coverage areas of neighbouring lowest level distributed search servers, determining whether the geographical coverage area of the lowest level distributed search server overlaps excessively with geographical coverage areas of the neighbouring lowest level distributed search servers and, if so, reducing the geographical coverage area of the lowest level distributed search server.

31. The method of claim 30 wherein determining whether the geographical coverage area of the lowest level distributed search server overlaps excessively with geographical coverage areas of the neighbouring lowest level distributed search servers comprises identifying a portion of the geographical coverage area that could be eliminated from the geographical coverage area, and determining whether all of the local listing servers in the identified portion of the geographical coverage area are covered by more than a threshold number of other distributed search servers.

32. The method of claim 1 comprising running on the user computer system a higher level distributed search server, the higher level distributed search server causing the user computer system to maintain a list of network addresses and coverage of one or more lower level distributed search servers in a coverage area of the higher level distributed search server.

33. The method of claim 1 wherein the classification data structure comprises a hierarchy of institutions and each listing is classified based on its originating institution.

34. A method for searching for classified listings, the method comprising:
a) providing a search query including a locality criterion identifying a geographical area of interest;
b) using the locality criterion to identify a plurality of local listing servers which at least partially cover the geographical area of interest, each of the local listing servers maintaining a local listings database;
c) forwarding the search query to the plurality of local listing servers;
d) receiving search results from the plurality of local listing servers; and,
e) combining the search results.

35. The method of claim 34 wherein identifying the plurality of local listing servers comprises, communicating the locality information to at least one search server and receiving from the at least one search server information identifying the plurality of local listing servers.

36. The method of claim 35 wherein the information identifying the plurality of search servers comprises network addresses for the plurality of local listing servers.

37. The method of claim 34 comprising initializing a local listing servers by broadcasting a network address for the local listing server to one or more of the search servers.

38. A method for maintaining an index to listings distributed on a plurality of geographically separated computer systems, the method comprising:
a) initializing a search server associated with an initial coverage area;
b) obtaining information identifying a set of computer systems containing listings in the coverage area;
c) generating and sending to the computer systems in the set information identifying the search server;
d) receiving at the search server listing information identifying listings held at the computer systems; and,
e) indexing the listing information.

39. A computer-implemented method for creating and distributing classified listings, the method comprising:
a) providing on a computer network a classification data structure providing a plurality of classifications;
b) on a network-connected computer system providing local listing server software which, when invoked on a user computer system, causes the user computer system to:
download a copy of the classification data structure;
provide a user interface providing facilities for creating, maintaining, and deleting listings from a listings database maintained on the user computer system, each of the listings associated with at least one of the classifications; and,
upload information about listings from the local listings database to one or more other computer systems on the network; and,
c) receiving and storing at one or more listing servers connected to the network listing information, the listing information corresponding to listings in the listings databases of a plurality of user computer systems, the one or more listing servers each comprising a search engine capable of receiving a query from a user computer system, executing the query and returning a result set comprising listing information corresponding to one or more of the listings.

40. The method of claim 39 wherein there are a plurality of listing servers and the method comprises receiving the search query at a plurality of the listing servers, processing the search query at each of the plurality of listing servers and returning a result set to the requesting user computer system from each of the plurality of search servers.

41. The method of claim 40 comprising, at the requesting user computer system, consolidating the result sets received at the requesting user computer system by at least removing duplicates from the result sets.

42. The method of claim 39 comprising providing on a server on the network a locality data structure comprising a plurality of localities and downloading at least a portion of the locality data structure to one or more user computer systems, wherein the local listing server requires users to associate listings with at least one of the localities of the locality data structure.

43. The method of claim 40 comprising periodically causing one or more of the listing servers to request listing information from local listing servers on one or more of the user computer systems and periodically receiving and storing uploaded listing information provided by the user computer systems in response to such requests at the one or more listing servers.

44. The method of claim 43 wherein the one or more listing servers each comprise a central search server which maintains coordinate information which identifies a geographic location for each of a plurality of user computer systems,
the method comprising receiving from a requesting user computer system at the central search server a request for listings originating from user computer systems having a specified proximity to the requesting user computer system,
using the coordinate location to identify a set of listings originating from user computer systems having the specified proximity and returning listing information corresponding to the set of listings to the requesting user computer system.

45. The method of claim 44 comprising associating each listing with a grid unit, each grid unit comprising a range of coordinate information, at the central search server, identifying from the specified proximity and the coordinate information for the requesting user computer system one or more grid units for which listings could match the specified proximity and compiling the set of listings from listings associated with the one or more grid units.

46. The method of claim 44 comprising providing a web server associated with one or more of the central search servers, the method comprising receiving queries by way of the web server, submitting the queries to the central search server, receiving the result sets at the web server, and displaying the result sets of such queries by way of the web server.

47. The method of claim 39 wherein a plurality of user computer systems on the network comprise distributed search server software, the distributed search server software, when run, causing the user computer system to: receive and store in a coverage index the network address and coverage of local listing servers of a plurality of user computer systems; and receive and process queries from other user computer systems.

48. The method of claim 47 wherein the coverage of each local listing server is defined geographically, by classification, by tagword, and/or by keyword.

49. The method of claim 47 wherein the distributed search server software includes instructions which, when run on a user computer system, cause the user computer system to generate and send by way of the network communication messages to the user computer systems listed in the coverage index.

50. The method of claim 49 wherein the local listing server software includes instructions which, when run on a user computer system, cause the user computer system to maintain a reverse coverage set index containing network addresses and coverage of user computer systems from which communication messages have been received.

51. The method of claim 50 wherein the local listing server software includes instructions which, when run on a user computer system, cause the user computer system to periodically send alive messages to the user computer systems in the reverse coverage set index.

52. The method of claim 47 comprising, providing on the network a plurality of distributed search servers organized in a hierarchy of levels, each level of distributed search servers comprising one or more distributed search servers which maintain indices of network addresses and coverage of one or more distributed search servers at a next-lower level.

53. The method of claim 52 comprising, at a requesting user computer system running local search server software, generating a query comprising a locality criterion, forwarding the query on the network to one or more higher-level distributed search servers, and receiving from the one or more higher-level distributed search servers a search set comprising network addresses of one or more next-lower level distributed search servers which satisfy the locality criterion.

54. The method of claim 53 comprising successively repeating forwarding the query on the network to the next-lower level distributed search servers in the search set until a set of lowest level distributed search servers which match the locality criterion is obtained.

55. The method of claim 54 comprising, at a requesting user computer system running local listing server software, forwarding the query to the set of lowest level distributed search servers, and receiving from one or more of the lowest-level distributed search servers in the set a search set comprising one or more user computer systems running local listing servers which satisfy the locality criterion.

56. The method of claim 55 comprising, at the requesting user computer system, forwarding the query to the local listings servers in the search set, and receiving from one or more of the local listings servers in the search set listings that satisfy the query.

57. The method of claim 54 comprising, at the requesting user computer system, removing any duplicates from each search set before forwarding the query to the network addresses in the search set.

58. The method of claim 39 comprising, at a requesting user computer system, receiving listing information from a plurality of the local listing servers at temporally spaced apart times, consolidating the received listing information and displaying at the requesting user computer system one or more listings in the consolidated received listing information and subsequently receiving and displaying additional listing information from at least one of the local listing servers.

59. The method of claim 51 wherein each of the distributed search servers has a coverage set and the method comprises, at one or more of the distributed search servers at each level of the hierarchy, intersecting the search locality criterion with the coverage set to obtain network addresses for one or more next-level down distributed search servers.

60. The method of claim 39 wherein the local listing server software comprises network addresses for one or more highest-level distributed search servers.

61. The method of claim 39 comprising invoking the local listing server on a plurality of user computer systems, maintaining a reverse coverage set at each of the local listing servers and, at each of the local listings servers, periodically sending listings from the local listings database to the local listings servers in the reverse coverage set.

62. The method of claim 61 comprising, maintaining a coverage set for each of the local listing servers, at each local listings server, receiving listings from other local listing servers in the corresponding coverage set, and, adding the received listings to the local listings database of the local listing server.

63. The method of claim 51 wherein the local listing server software comprises computer instructions which, when executed on a user computer system, cause the user computer system to invoke a distributed search server.

64. The method of claim 63 wherein the local listing server periodically determines whether or not to invoke the distributed search server at least in part on the basis of a random factor.

65. The method of claim 63 wherein the local listing server periodically determines whether or not to commence running the distributed search server at least in part on the basis of a current capacity of the user computer system.

66. The method of claim 63 wherein the local listing server periodically determines whether or not to commence running the distributed search server on the basis of a random factor and a probability based upon a current capacity of the user computer system.

67. The method of claim 63 comprising invoking the distributed search server on a user computer system and, upon invoking the distributed search server, executing at the user computer system computer instructions which cause the user computer system to create a database of other user computer systems that meet a locality criterion relative to a locality of the user computer system.

68. The method of claim 67 comprising invoking the distributed search server on a user computer system and, upon invoking the distributed search server, at the user computer system executing computer instructions which cause the user computer system to create a database of other user computer systems that contain listings associated with a specified classification, locality, keyword, or tagword.

69. The method of claim 39 wherein the local listing server causes the user computer system to periodically upload the listing information from the local listings database to one or more search servers and the method comprises periodically receiving and storing the uploaded listing information at the one or more search servers.

70. The method of claim 69 wherein the one or more search servers comprise a plurality of central search servers and each of the central search servers contain an aggregation of listing information relating to listings in a defined geographical area.

71. The method of claim 69 wherein the one or more search servers comprise a plurality of central search servers and each of the central search servers contain an aggregation of listing information relating to listings in a defined set of one or more classifications.

72. The method of claim 39 comprising receiving at a server a request for:
the classification data structure, the locality data structure, a portion of the classification data structure, or a portion of the locality data structure from a local listing server running on a user computer system and,
delivering a copy of the requested classification data structure, the locality data structure, portion of the category data structure or portion of the locality data structure to the local listing server by way of the network.

73. The method of claim 39, wherein the listing information comprises version information and the method comprises receiving listing information at a listing server, comparing the received listing information to corresponding listing information previously stored at the listing server and, if the version information indicates that the received listing information is a more recent version than the stored listing information, replacing the stored listing information with the received listing information.

74. The method of claim 39 wherein the local listing software comprises instructions which cause a user computer system to receive from a user a query comprising a locality condition or a classification condition, to select a search server on the basis of the locality condition, the classification condition, or both the locality condition and the classification condition and to direct the query to the selected search server.

75. The method of claim 39 comprising, at a search server, identifying frequencies with which words occur in the listing information stored at the search server, compiling a list of highest frequency words, eliminating common words, and forwarding the resulting set of words to one of the local listing servers for selection as tagwords by a user.

76. The method of claim 39 comprising receiving at a search server ratings of listings submitted by users, automatically rejecting any rating submitted by a user for a listing submitted by the same user, and compiling submitted ratings to provide rating information associated with listings.

77. The method of claim 76 comprising, at the search server, receiving a request for listings, locating a set of listings which match the request and excluding from the set listings for which the rating information is unfavorable.

78. The method of claim 76 wherein the local listing server software comprises computer instructions which, when executed by a user computer system, suppress the display of or reduce the display priority of listings for which the relevance rating information indicates that the listing is of low relevance.

79. The method of claim 39 wherein the listing information comprises contact information for establishing peer-to-peer communication with an originator of the listing.

80. The method of claim 79 wherein the local listing server software comprises computer instructions which cause a user computer system to: initiate peer-to-peer communication based on contact information in a listing, and maintain a log of all such peer-to-peer communications.

81. The method of claim 80 wherein the contact information comprises an email address or an instant messaging application name and User ID.

82. The method of claim 39, wherein the local listing server software comprises instructions that, when executed on a user computer system cause the user computer system to determine whether another user computer system from which a listing originated is online and, if so, to display a visual indicator along with a display representing the listing.

83. The method of claim 47 comprising invoking a plurality of distributed search servers by running the distributed search server software on a plurality of user computer systems wherein each of the distributed search servers covers a geographical coverage area and the method comprises determining if a computer system on which the distributed search server is running has sufficient resources to permit expanding the geographical coverage area, and, if so, expanding the geographical coverage area.

84. The method of claim 83 comprising, at one or more of the distributed search servers, obtaining information about the geographical coverage areas of neighbouring distributed search servers, determining whether the geographical coverage area of the distributed search server overlaps excessively with geographical coverage areas of the neighbouring distributed search servers and, if so, reducing the geographical coverage area of the distributed search server.

85. The method of claim 84 comprising comparing a coverage radius of one of the distributed search servers to a threshold value and discontinuing operation of the distributed search server if the coverage radius is less than the threshold.

86. The method of claim 84 wherein determining whether the geographical coverage area of the distributed search server overlaps excessively with geographical coverage areas of the neighbouring distributed search servers comprises identifying a portion of the geographical coverage area that could be eliminated from the geographical coverage area, and determining whether all of the local listing servers in the identified portion of the geographical coverage area are covered by more than a threshold number of other distributed search servers.

87. The method of claim 83 comprising invoking a higher-level distributed search server process at a randomly selected time.

88. The method of claim 39 wherein the local listing server user interface permits the entry of queries by keyword, tagword, classification, and/or locality.

89. The method of claim 39 comprising receiving from a local listing server a new sub-classification for classifying listings and adding the new sub-classification to the classification data structure.

90. The method of claim 89 comprising associating a set of rules with one or more user-created sub-classifications.

91. The method of claim 39 providing, at the search server, associating a set of one or more criteria with an on-line listing service and automatically posting the listing information for listings which satisfy the set of one or more criteria to the on-line listing service.

92. The method of claim 91 wherein the on-line listing service comprises a Usenet group.

93. The method of claim 39 wherein the listing information comprises rich text or HTML information comprising hyperlinks.

94. The method of claim 39 comprising maintaining at the search server a list of criteria of interest to a user, checking listings at the search server to determine whether they match the criteria and, alerting the user by way of the network that a listing which matches such criteria has been detected.

95. The method of claim 39 wherein the user interface comprises a display of a list of classifications from the classification data structure and the method comprises suppressing the display of classifications in which there are no listings.

96. The method of claim 95 comprising maintaining at the search server a count of a number of listings associated with each classification in a classification data structure, and forwarding the count to one or more user computer systems together with the classification data structure.

97. The method of claim 39 wherein the user interface comprises a display of a list of localities from a localities data structure and the method comprises suppressing the display of localities in which there are no listings.

98. The method of claim 95 comprising maintaining at the search server a count of a number of listings associated with each locality in a locality data structure, and forwarding the count to one or more user computer systems together with the locality data structure.

99. The method of claim 39 wherein the listing information for one or more listings comprises information for retrieving from a user computer system an attachment to a listing corresponding to the listing information.

100. The method of claim 39, wherein the user interface comprises a visual status indicator corresponding to listing information received in response to a query, the listing information comprises status information which indicates whether or not the listing is sold and, the local listing server software comprises computer instructions which, if the status information indicates that the listing is sold, cause the visual status indicator for the listing to change appearance to indicate that the listing is sold.

101. The method of claim 100, wherein the user interface comprises an acceptance control which, when operated by a user, generates and sends to an originator of a listing a message signifying agreement with terms in a currently selected listing.

102. The method of claim 101, comprising automatically providing a form to a person who agrees to pay money to another user by operating the acceptance control, the form comprising one or more fields for receiving credit information identifying an account and a confirmation control which, when operated by a user, indicates an assent to having charges made to the account.

103. The method of claim 39 comprising, at the search server, receiving a query including a classification and forwarding a list of localities for which the stored listing information identifies listings associated with both the received classification and the locality.

104. The method of claim 103 wherein the search server determines a number of listings in the received classification in each of the localities in the list.

105. The method of claim 39 comprising, at the search server, receiving a query including a locality and forwarding a list of classifications for which the stored listing information identifies listings associated with both the received locality and the classification.

106. The method of claim 105 wherein the search server determines a number of listings in the received locality in each of the classifications in the list.

107. The method of claim 39 wherein one or more of the search servers holds information associating users with one or more communities; the listing information includes community information specifying a community to which the corresponding listing relates; and the search server excludes from the result set listing information which specifies a community to which the requesting user does not belong.

108. The method of claim 39, wherein the user interface comprises a template associated with each of one or more classifications of the classification data structure or one or more localities of the locality data structure, the template defines specific information for inclusion in a listing and the user interface applies the template in response to a user selecting a classification or locality corresponding to the template.

109. The method of claim 39 wherein the search server comprises a database comprising business advertisements each associated with the classifications, in response to receiving from a user computer a query including a classification, the search server locates a business advertisement which matches the query classification, and forwards the business advertisement to the user computer system for display.

110. The method of claim 39 wherein the search server continues to store expired listings and responds to queries for expired listings with a set of expired listings that match the query criteria.

111. The method of claim 47 comprising, providing on the network a distributed search server running on a user computer, the distributed search server maintaining a coverage index including network addresses for one or more user computer systems covered by the distributed search server,
periodically receiving at the distributed search server alive notices by way of the network from user computer systems, and,
upon receipt of an alive notice from a user computer system not in the coverage index, adding the user computer system to the coverage index.

112. The method of claim 111 comprising removing a user computer system from the coverage index if an alive notice is not received from that user computer system within a time period.

113. Apparatus for publishing classified listings, the apparatus comprising:
a) a processor
b) a user interface;
c) a locally stored classification data structure defining a plurality of classifications;
d) a database for storing listings;
e) stored geographical location information; and,
f) software which, when executed on the processor, causes the processor to receive listing information defining a listing from the user interface, the listing information including a selection of one of the classifications, and to store the listing information in the database together with the stored geographical location information.

114. A program product comprising a computer readable medium carrying signals corresponding to computer instructions which, when executed by a computer, cause the computer to perform a method according to claim 1.

115. A method for obtaining a file in a peer-to-peer file transfer system, the method comprising:
a) requesting a file in a peer-to-peer manner;
b) waiting for a period;
c) if the file has not been received then requesting a copy of the file from a central server.
